(19) United States
(12) Patent Application Publication
(10) Pub. No.: US 2007/0070476 A1
(43) Pub. Date: Mar. 29, 2007

(54) Three-dimensional display

(75) Inventors: Masahiro Yamada, Kanagawa (JP); Sunao Aoki, Kanagawa (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/520,355

(22) Filed: Sep. 13, 2006

(30) Foreign Application Priority Data
Sep. 20, 2005 (JP) JP2005-271775

(51) Int. Cl. G03H 1/08

(52) U.S. Cl. 359/9

(57) ABSTRACT

In the three-dimensional display, a two-dimensional display section generates a two-dimensional display image based on an image signal, and a lens array converts the wavefront of the display image light from the two-dimensional display section into a wavefront having a curvature which allows the display image light to focus upon a focal point where an optical path length from an observation point to the focal point is equal to an optical path length from the observation point to a virtual object point, so a viewer can obtain information about an appropriate focal length in addition to information about binocular parallax and a convergence angle. Therefore, consistency between the information about binocular parallax and a convergence angle and the information about an appropriate focal length can be ensured, and a desired stereoscopic image can be perceived without physiological discomfort.

### CROSS REFERENCES TO RELATED APPLICATIONS

The present invention contains subject matter related to Japanese Patent Application JP 2005-271775 filed in the Japanese Patent Office on Sep. 20, 2005, the entire contents of which being incorporated herein by reference.

### BACKGROUND OF THE INVENTION

1. Field of the Invention

The present invention relates to a three-dimensional display which displays a stereoscopic image of an object in space.

2. Description of the Related Art

Examples of methods of generating a stereoscopic image in related arts include a method of sending different images (parallactic images) to the right eye and the left eye of a viewer wearing glasses with different color lenses, a method of sending parallactic images to the right eye and the left eye of a viewer wearing goggles with liquid crystal shutters while switching the liquid crystal shutters at high speed, and the like. Moreover, there is a method of displaying a stereoscopic image by displaying an image for the right eye and an image for the left eye on a two-dimensional display, and distributing the images to the eyes by a lenticular lens. Further, as a method similar to the method using the lenticular lens, a method of displaying a stereoscopic image by arranging a mask on the surface of a liquid crystal display so that the right eye and the left eye can see an image for the right eye and an image for the left eye, respectively has been developed.

The generation of a stereoscopic image is achieved by using human perceptual physiological functions. In other words, a viewer perceives a three-dimensional object in a step of comprehensively processing a perception by a difference between images seen by the right and left eyes (binocular parallax) or a convergence angle, a perception by a physiological function (a focal length adjustment function) which occurs at the time of adjusting the focal length of the crystalline lens in the viewer's eye through the use of the ciliary body or the ciliary zonule of the eye, and a perception (motion parallax) by a change in images seen when the viewer moves in the viewer's brain. Therefore, in the case where consistency between the perceptions is not maintained, his brain is confused to cause stress or the feeling of fatigue. Thereby, to display a more natural stereoscopic image, it is necessary to use a method which can maintain consistency between the perceptions.

However, the stereoscopic image by the above-described techniques is generated through the use of only “binocular parallax” or “convergence angle” in human perceptual physiological functions. Therefore, it is perceived from information from the focal length adjustment function of the eye that the stereoscopic image exists on a flat display surface, and it is perceived from information from the binocular parallax or the convergence angle that a stereoscopic image with depth exists. In his brain, these different perceptions are processed, thereby his brain perceives the different perceptions as discomfort or unpleasant feeling to cause stress or fatigue. Moreover, a change in images which can be seen when the viewer moves is not perceived, so discomfort due to this is added.

In Japanese Patent No. 3077930, a three-dimensional display including a plurality of one-dimensional displays and a deflection section which deflects a display pattern from each of the one-dimensional displays in the same direction as each arrangement direction is disclosed. In Japanese Patent No. 3077930, it is described that in the three-dimensional display, a plurality of output images are perceived at the same time by the afterimage effect of eyes, and the output images can be perceived as a stereoscopic image by binocular parallax. However, it is inevitable that the focal length is perceived fixed, so it is expected that it is difficult to avoid discomfort. Furthermore, in reality, an image for each eye of the viewer enters the other eye, so it is considered that in addition to not obtaining the binocular parallax, there is a high possibility that the viewer perceives a double image.

On the other hand, in the real world, information from the surface of an object propagates to the eyeballs of the viewer by a light wave as a medium. A physical technique capable of artificially recreating a light wave from a real-world object is holography. A stereoscopic image in holography is generated by using an interference pattern formed by the interference of light, and using a diffracted wavefront formed when the interference pattern is illuminated by light as an image information medium. Therefore, the same physiological visual responses such as convergence and adjustment as those when the viewer observes an object in the real world occur, thereby an image which causes less eye strain can be provided. Moreover, recreating the light wavefront from the object means securing continuity in a direction where image information is transmitted. Therefore, when the viewpoint of the viewer moves, appropriate images from different angles according to the moving viewpoint can be continuously provided, and holography is an image providing technique which continuously provides motion parallax.

### SUMMARY OF THE INVENTION

The above-described holography is a method of recording and recreating a diffracted wavefront from an object, so it is considered that the holography is an extremely ideal method of displaying a stereoscopic image.

However, in the holography, three-dimensional spatial information is recorded as interference patterns in two-dimensional space, and compared to spacial frequency in the two-dimensional spatial information such as a photograph of the same object, spatial frequency in the three-dimensional spatial information is extremely enormous. It can be considered that when three-dimensional spatial information is converted into two-dimensional spatial information, the three-dimensional spatial information is converted into density on two-dimensional space. Therefore, the spatial resolution which is necessary for a device displaying interference patterns by a CGH (Computer Generated Hologram) is extremely high, and an enormous amount of information is necessary, so under the present circumstances, it is technically difficult to display a stereoscopic image in a real-time hologram. Moreover, as light used at the time of recording, coherent light such as laser light is necessary, so it is very difficult to record (photograph) with natural light.

In view of the foregoing, it is desirable to provide a three-dimensional display capable of generating a stereoscopic image which can be perceived without physiological discomfort while using a light beam similar to natural light.

According to an embodiment of the invention, there is provided a three-dimensional display, including: a two-dimensional image generating means for generating a two-dimensional display image based on an image signal; a wavefront conversion means for converting the wavefront of display image light emitted from the two-dimensional image generating means into a wavefront having a curvature which allows the display image light to focus upon a focal point, an optical path length from an observation point to the focal point being equal to an optical path length from the observation point to a virtual object point; and a deflection means for deflecting the display image light, the wavefront of the display image light being converted by the wavefront conversion means.

In the three-dimensional display according to the embodiment of the invention, the two-dimensional image generating means generates a two-dimensional display image based on an image signal, and the wavefront conversion means converts the wavefront of display image light emitted from the two-dimensional image generating means into a wavefront having a curvature which allows the display image light to focus upon a focal point where an optical path length from an observation point to the focal point is equal to an optical path length from the observation point to a virtual object point. Therefore, the display image light includes not only information about binocular parallax and a convergence angle but also information about an appropriate focal length. Moreover, the deflection means deflects the display image light of which the wavefront is converted by the deflection means, so desired display image light is directed toward each of the right and left eyes of a viewer.

In the three-dimensional display according to the embodiment of the invention, the two-dimensional image generating means generates a two-dimensional display image based on an image signal, and the wavefront conversion means converts the wavefront of display image light emitted from the two-dimensional image generating means into a wavefront having a curvature which allows the display image light to focus upon a focal point where an optical path length from an observation point to the focal point is equal to an optical path length from the observation point to a virtual object point, so the viewer can obtain information about an appropriate focal length in addition to information about binocular parallax and a convergence angle. Therefore, consistency between the information about binocular parallax and a convergence angle and the information about an appropriate focal length can be ensured, and a desired stereoscopic image can be perceived without physiological discomfort.

Other and further objects, features and advantages of the invention will appear more fully from the following description.

### BRIEF DESCRIPTION OF THE DRAWINGS

FIG. 1 is a schematic view of the structure of a three-dimensional display according to a first embodiment of the invention;

FIGS. 2A, 2B and 2C are schematic views of the structures of a two-dimensional display section and a collimation section in the three-dimensional display shown in FIG. 1;

FIGS. 3A, 3B and 3C are schematic views of other structures of the two-dimensional display section and the collimation section in the three-dimensional display shown in FIG. 1;

FIG. 4 is a schematic view of the structure of a lens array in the three-dimensional display shown in FIG. 1;

FIGS. 5A and 5B are an enlarged plan view and an enlarged sectional view of the structure of a variable focal-length lens in the lens array shown in FIG. 4;

FIGS. 6A and 6B are enlarged sectional views for describing the operation of the variable focal-length lens shown in FIGS. 5A and 5B;

FIGS. 7A and 7B are other enlarged sectional views for describing the operation of the variable focal-length lens shown in FIGS. 5A and 5B;

FIGS. 8A and 8B are a plan view and a sectional view of the structure of a horizontal deflection section in the three-dimensional display shown in FIG. 1;

FIG. 9 is another plan view of the structure of the horizontal deflection section in the three-dimensional display shown in FIG. 1;

FIGS. 10A, 10B and 10C are enlarged sectional views for describing the operation of a light deflection device in the horizontal deflection section shown in FIGS. 8A and 8B;

FIG. 11 is a sectional view for describing the whole operation of the light deflection device in the horizontal deflection section shown in FIGS. 8A and 8B;

FIG. 12 is a plan view for describing a positional relationship between the horizontal deflection section and a vertical deflection section in the three-dimensional display shown in FIG. 1;

FIG. 13 is a conceptual diagram for describing the operation when a stereoscopic image is observed on the three-dimensional display shown in FIG. 1;

FIG. 14 is another conceptual diagram for describing the operation when a stereoscopic image is observed on the three-dimensional display shown in FIG. 1;

FIGS. 15A and 15B are a plan view and a sectional view of the structure of a variable focal-length lens as a first modification (Modification 1) in the three-dimensional display shown in FIG. 1;

FIGS. 16A and 16B are a plan view and a sectional view of the structure of a variable focal-length lens as a second modification (Modification 2) in the three-dimensional display shown in FIG. 1;

FIGS. 17A and 17B are a plan view and a sectional view of the structure of a variable focal-length lens as a third modification (Modification 3) in the three-dimensional display shown in FIG. 1;

FIG. 18 is a schematic view of the structure of a three-dimensional display according to a second embodiment of the invention;

FIG. 19 is a schematic view of the structure of a mirror array in the three-dimensional display shown in FIG. 18;

FIG. 20 is a sectional view of the structure of a variable focal-length lens as an example of the invention;

FIG. 21 is a plot showing a relationship between an applied voltage and an attractive force generated between electrode layers in the example;

FIG. 22 is a plot showing a relationship between an attractive force and deformation in the example;

FIGS. 23A, 23B and 23C are schematic views of a two-dimensional image generating means and a light collimation means according to modifications (Modifications 4 and 5) of the invention;

FIG. 24 is a schematic view of a two-dimensional image generating means and a light collimation means according to a modification (Modification 6) of the invention;

FIG. 25 is a schematic view of a two-dimensional image generating means and a light collimation means according to a modification (Modification 7) of the invention;

FIG. 26 is a schematic view of a two-dimensional image generating means and a light collimation means according to a modification (Modification 8) of the invention;

FIG. 27 is a schematic view of a two-dimensional image generating means and a light collimation means according to a modification (Modification 9) of the invention;

FIGS. 28A and 28B are schematic views of a light deflection device in a deflection means according to a modification (Modification 10) of the invention;

FIGS. 29A and 29B are schematic views of an optical device in a deflection means and a wavefront conversion means according to a modification (Modification 11) of the invention; and

FIG. 30 is a schematic view of a modification (Modification 12) of the mirror array shown in FIG. 19.

### DETAILED DESCRIPTION OF THE PREFERRED EMBODIMENTS

Preferred embodiments will be described in detail below referring to the accompanying drawings.

### First Embodiment

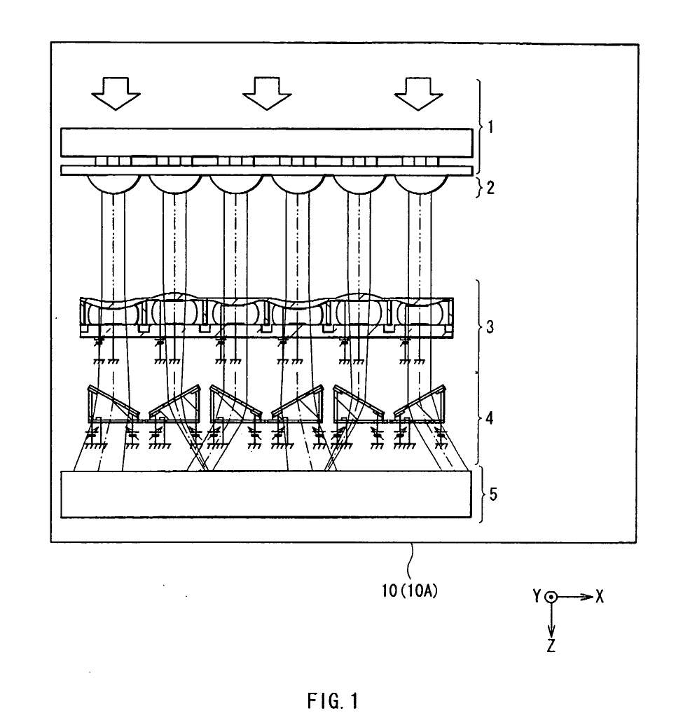

At first, a three-dimensional display 10 (to distinguish from a second embodiment which will be described later, hereinafter referred to as three-dimensional display 10A) according to a first embodiment of the invention will be described below. FIG. 1 shows a structural example of the three-dimensional display 10A. FIG. 1 is a schematic view in a horizontal plane.

The three-dimensional display 10A includes a two-dimensional display section 1 having a plurality of pixels, a collimation section 2 converting the wavefront of display image light emitted from each pixel into a parallel light flux, a lens array 3 converting the wavefront of the parallel light flux converted in the collimation section 2 into a wavefront having a curvature which allows the display image light to focus upon a focal point where an optical path length from an observation point to the focal point is equal to an optical path length from the observation point to a virtual object point, a horizontal deflection section 4 deflecting the light flux from the lens array 3 in a horizontal direction, and a vertical deflection section 5 deflecting the light flux from the horizontal deflection section 4 in a vertical direction.

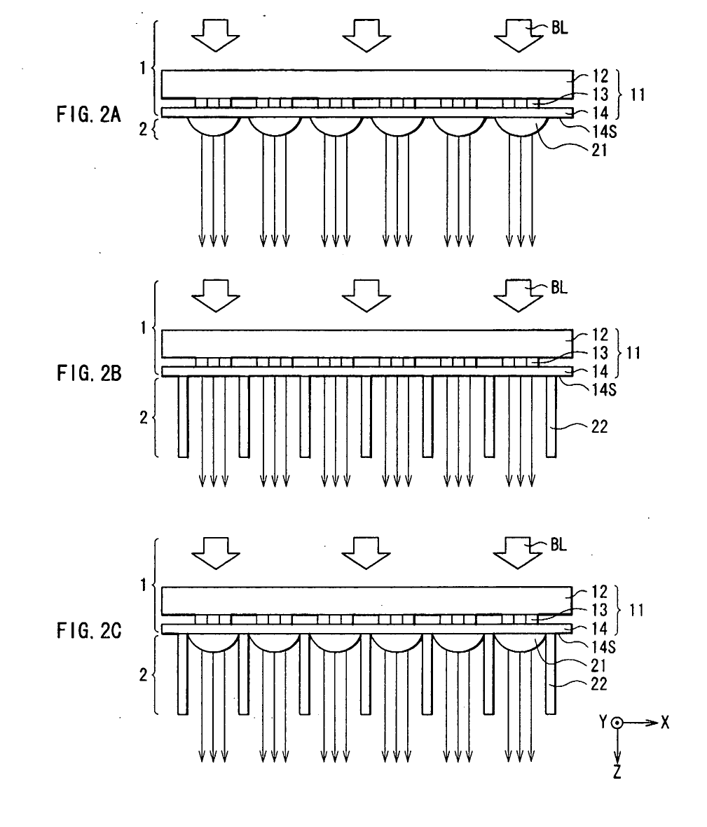

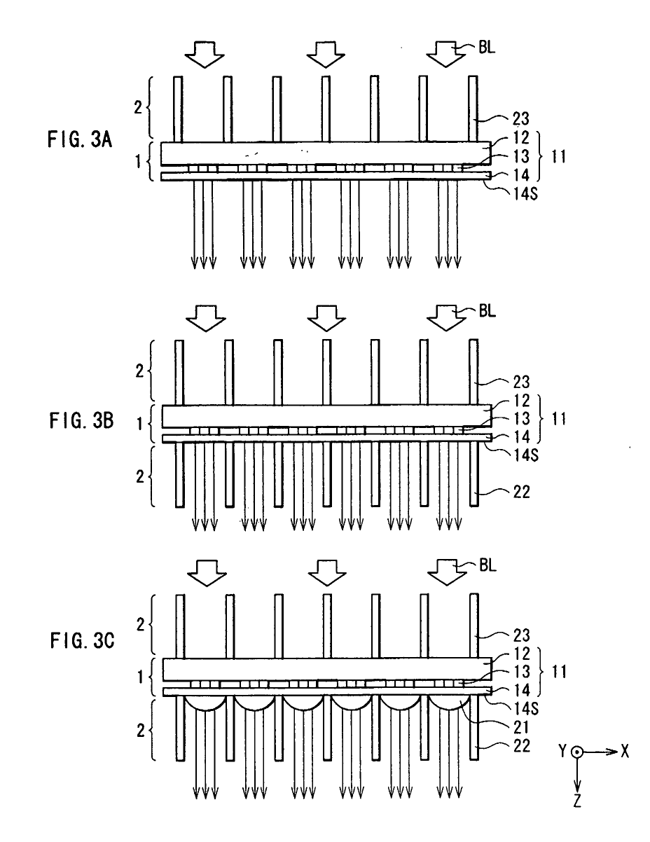

FIG. 2A shows a structural example of the two-dimensional display section 1 as a two-dimensional image generating means and the collimation section 2 as a light collimation means. The two-dimensional display section 1 uses a color liquid crystal device (hereinafter simply referred to as liquid crystal device) as a display device, and as backlight BL for the liquid crystal device, a typical fluorescent light instead of parallel light is used. The liquid crystal device 11 has a structure in which a glass substrate 12, a pixel electrode 13 and a glass substrate 14 are laminated in order. A liquid crystal layer (not shown) or the like is further arranged between two glass substrates 12 and 14. Moreover, the collimation section 2 includes, for example, a microlens 21 with a convex shape which is arranged on a surface 14S of the glass substrate 14. In this case, the liquid crystal device 11 emits display image light by irradiation with the backlight BL. The display image light is a group of lights propagating in all directions, so the display image light is converted into a parallel light flux by the microlens 21 on a pixel-to-pixel basis.

As shown in FIG. 2B, as the collimation section 2, a partition wall 22 may be included instead of the microlens 21. The partition wall 22 is placed in the middle position between adjacent pixel electrodes 13, and is placed upright perpendicular to the surface 14S of the glass substrate 14 (along a Z direction). In this case, the partition wall 22 is made of a material which absorbs the display image light (for example, a resin material in which carbon is dispersed), or a partition wall of which the surface is covered with a light absorbing material such as gold black, so unnecessary reflected light is blocked. Therefore, the propagation of the display image light emitted from the two-dimensional display section 1 in an in-plane direction parallel to the surface 14S is limited, and the display image light propagates in a direction perpendicular to the surface 14S (a Z-axis direction). The partition wall 22 is placed so as to separate adjacent pixel electrodes 13 not only in a horizontal direction (an X-axis direction) but also in a vertical direction (a Y-axis direction).

Moreover, as shown in FIG. 2C, a combination of the microlens 21 and the partition wall 22 may be the collimation section 2. In this case, the conversion efficiency into a parallel light flux can be improved.

Further, as shown in FIG. 3A, the partition wall 23 as the collimation section 2 may be placed upright not on the surface 14S of the glass substrate 14 but on a surface 12S (a surface irradiated with the backlight BL) of the glass substrate 12. Thereby, the backlight BL is converted into a parallel light flux before the backlight BL enters the liquid crystal device 11, so the display image light emitted from the liquid crystal device 11 is a parallel light flux.

As shown in FIG. 3B, in addition to the partition wall 23, a partition wall 22 can be placed on the surface 14S. In this case, the backlight BL is converted into a parallel light flux by the partition wall 23, and, for example, unnecessary light scattered in the glass substrate 14 can be sufficiently removed by the partition wall 22.

As shown in FIG. 3C, the microlens 21 may be further included in the configuration shown in FIG. 3B. Thereby, collimated display image light can be more reliably obtained.

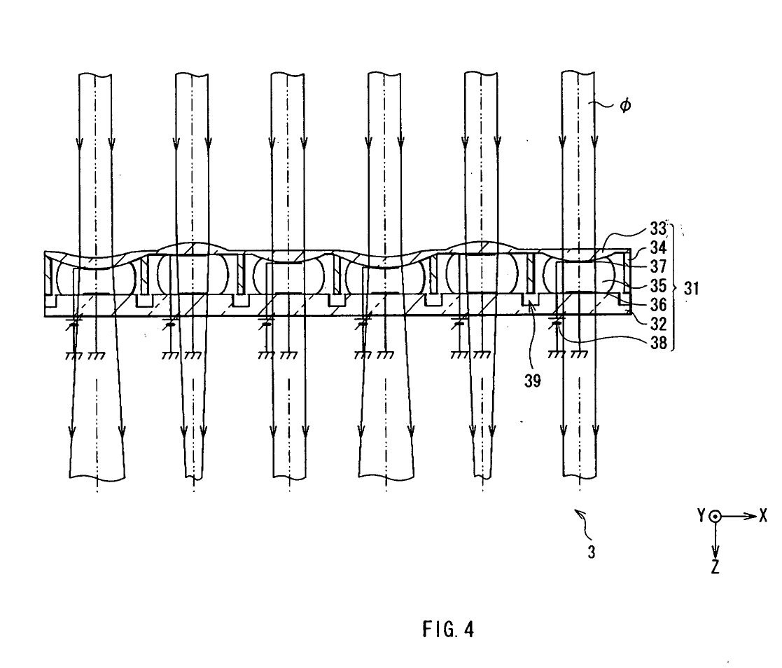

Next, the lens array 3 will be described below referring to FIG. 4. FIG. 4 shows a schematic sectional view of the lens array 3 as a wavefront conversion means.

As shown in FIG. 4, the lens array 3 includes a plurality of variable focal-length lenses 31. The variable focal-length lens 31 is an optical device capable of freely changing its focal length by deforming a part of its shape. Each variable focal-length lens 31 includes a transparent substrate 32 as a rigid layer, a transparent deformation member 33 as an elastic layer facing the transparent substrate 32, a column 34 which is arranged between the transparent substrate 32 and the transparent deformation member 33, a filling layer 35 which is filled in a space surrounded by the transparent substrate 32, the transparent-deformation member 33 and the column 34, and transparent electrode layers 36 and 37 which are arranged on a surface of the transparent substrate 32 and a surface of the transparent deformation member 33, respectively, and face each other. The transparent electrode layer 36 is grounded, and the transparent electrode layer 37 is connected to an external control power source 38. Moreover, a continuous hole 39 is arranged in a part of the column 34 so that ventilation to outside can be provided.

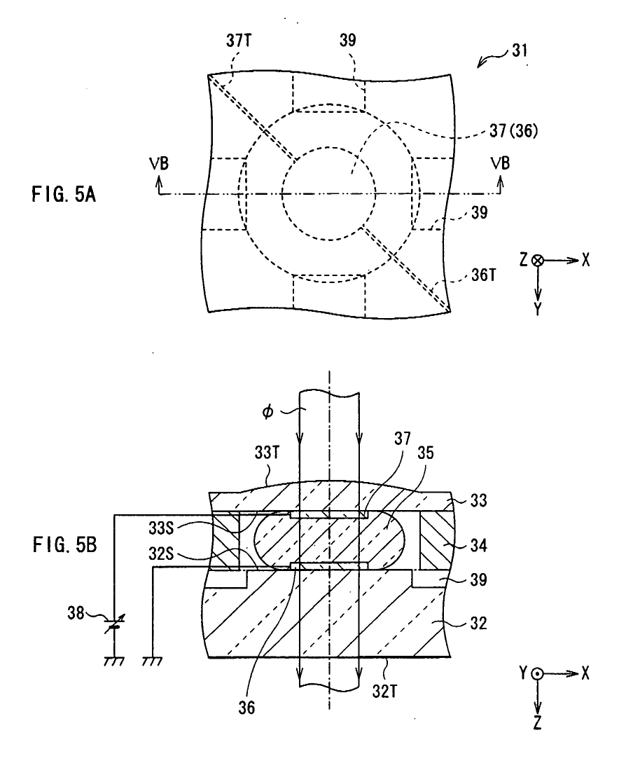

FIGS. 5A and 5B show enlarged views of the variable focal-length lens 31. FIG. 5A shows a plan view, and FIG. 5B shows a sectional view. FIG. 5B is a sectional view taken along a line VB-VB of FIG. 5A as viewed from an arrow direction. The transparent substrate 32 is made of, for example, a transparent material with high rigidity such as quartz. The column 34 is made of a high rigid material as in the case of the transparent substrate 32; however, the column 34 is not necessarily transparent. The transparent deformation member 33 which is arranged on the transparent substrate 32 so as to be supported by the column 34 is made of, for example, a polymer such as a transparent and flexible polyester material, and has a high elastic modulus. In this case, the transparent deformation member 33 has a thickness gradually reduced, for example, from a central part to a peripheral part in a region where a parallel light flux φ from the collimation section 2 passes through, and a surface 33T opposite to a surface 33S on which the transparent electrode layer 37 is disposed is convex (curved). On the other hand, the surface 33S is flat. Therefore, the transparent deformation member 33 exerts a function as a lens. Moreover, the composition of the polymer of which the transparent deformation member 33 is made is substantially homogenous, so the transparent deformation member 33 has an elastic-constant distribution in an in-plane direction (a direction where an XY plane expands). The elastic-constant distribution is produced by the distribution of the thickness of the transparent deformation member 33. As a method of molding such a transparent deformation member 33 in a desired shape, the transparent deformation member 33 may be processed by, for example, an injection molding method which is used to mold typical plastic lenses or optical disk substrates, or a method of partially evaporating an desired amount in a desired part of the surface of a polymer substrate through the use of a UV laser such as an excimer laser or an infrared light laser such as a carbon dioxide gas laser. Alternatively, in a typical semiconductor process, through the use of a typical reactive ion etching (RIE) apparatus or a typical ion milling apparatus, a desired part of the surface of a substrate may be partially vapor-phase etched (dry etched) by a desired amount. Further, a method by hot embossing or stamp molding may be used. On the other hand, the column 34 may be formed as one unit with the transparent substrate 32 through curving a base material such as quartz by, for example, a powder beam etching apparatus or a RIE apparatus. Alternatively, the column 34 which is separately formed may be bonded to the transparent substrate 32.

The transparent electrode layers 36 and 37 are made of a conductive polymer formed through dispersing metal such as gold or silver, carbon or the like into a non-conductive plastic such as polyolefin and processing the non-conductive plastic into a sheet shape, and the transparent electrode layers 36 and 37 are bonded to a surface 32S of the transparent substrate 32 and the surface 33S of the transparent deformation member 33, respectively, by a transparent adhesive. Alternatively, a conductive material such as carbon or ITO (Indium Tin Oxide) may be directly deposited on the surfaces 32S and 33S by a typical vacuum film formation apparatus such as a vacuum deposition apparatus, a sputtering apparatus, an ion plating apparatus or a CVC (Chemical Vapor Deposition) apparatus so as to form the transparent electrode layers 36 and 37. Moreover, the transparent electrode layers 36 and 37 may be formed through coating with a predetermined organic solvent or a predetermined solution into which ultrafine carbon particles or a conductive material such as gold or silver is dispersed by a spin coating apparatus. The transparent electrode layer 36 is grounded via a connecting line 36T, and the transparent electrode layer 37 is connected to the external control power source 38 via a connecting line 37T.

The filling layer 35 is made of, for example, a transparent and extremely flexible fluid material such as silicone. The filling layer 35 is filled in only a region including at least a region where the parallel light flux φ passes between the transparent substrate 32 and the transparent deformation member 33. The other region is secured as a buffer region having the continuous hole 39 connected to outer space. However, the filling layer 35 is arranged so that the whole transparent electrode layers 36 and 37 are covered with the filling layer 35.

In the variable focal-length lens 31 with such a structure, when a predetermined voltage is applied between the transparent electrode layer 36 and the transparent electrode layer 37 by the external control power source 38, an electrostatic force (a Coulomb force) is generated between the transparent electrode layer 36 and the transparent electrode layer 37, thereby they attract each other. The transparent electrode layer 36 is firmly fixed to the surface 32S of the transparent substrate 32, and the transparent electrode layer 37 is firmly fixed to the surface 33S of the transparent deformation member 33, so as a result, the transparent substrate 32 and the transparent deformation member 33 attract each other. At this time, the transparent substrate 32 is made of a material having relatively high rigidity, so the transparent substrate 32 is hardly deformed. On the other hand, the transparent deformation member 33 is made of a material with high elasticity, so relatively large deformation of the transparent deformation member 33 occurs. The transparent deformation member 33 is deformed according to the elastic-constant distribution determined by its thickness distribution, so when the transparent deformation member 33 is designed and processed so as to have a desired shape after deformation, a desired lens action can be obtained. At this time, through the use of a change in the electrostatic force according to the magnitude of the voltage applied between the transparent electrode layer 36 and the transparent electrode layer 37, continuously (or gradually) different shapes of the transparent deformation member 33 are selected and formed. The thickness distribution of the transparent deformation member 33 can be optimized on the basis of, for example, a simulation result by, for example, a finite element method (FEM). Thereby, the variable focal-length lens 31 capable of changing the focal length while maintaining a desired spherical or aspherical shape can be achieved. In addition, the filling layer 35 is deformed according to the deformation of the transparent deformation member 33; however, air in the buffer region is discharged to outside via the continuous hole 39, so the filling layer 35 is smoothly deformed.

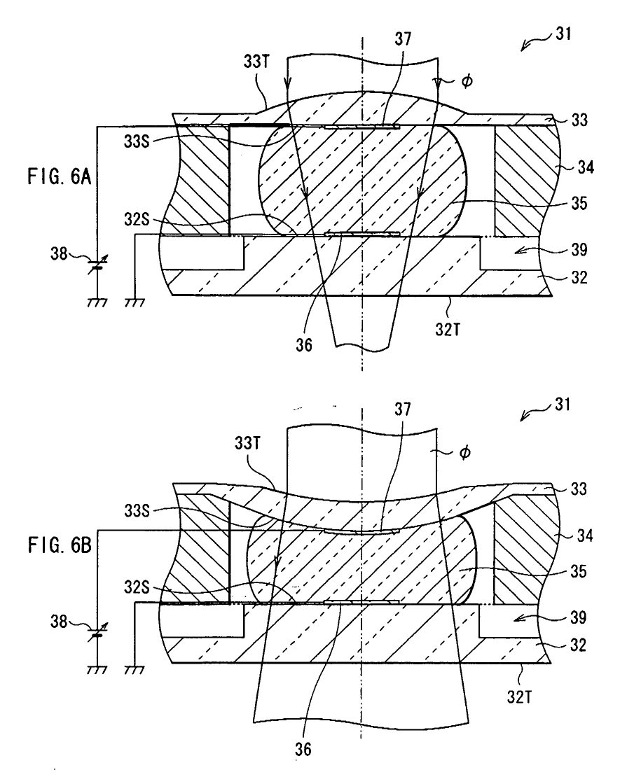

Referring to FIGS. 6A and 6B, the operation of the variable focal-length lens 31 will be described in detail below. To facilitate understanding, the case where the refractive indexes of the transparent substrate 32, the transparent deformation member 33 and the filling layer 35 are the same will be described below. However, in the invention, when the refractive indexes of these members are different from each other, an optical action actively using a difference between the refractive indexes can be obtained. FIG. 6A shows an initial state in which a voltage is not applied between the transparent electrode layers 36 and 37. At this time, the surface 33T as the entry side of the transparent deformation member 33 is not parallel to the surface 32T as the emission side of the transparent substrate 32, and has a convex shape on the entry side. Therefore, the variable focal-length lens 31 functions as a convex lens, and exerts a function of focusing an incident light flux φ. On the other hand, FIG. 6B shows a state where a predetermined voltage is applied between the transparent electrode layers 36 and 37. By the application of the voltage, an electrostatic force acts between the transparent electrode layers 36 and 37, and then the transparent deformation member 33 and the filling layer 35 are deformed so that the surface 33T becomes concave. At this time, the surface 32T is still flat. Therefore, in this case, the variable focal-length lens 31 acts as a concave lens, and exerts a function of dispersing the incident light flux φ. In this case, the transparent deformation member 33 has a predetermined thickness distribution (elastic-constant distribution), so when the applied voltage is adjusted, the shape of the surface 33T is appropriately selected. Therefore, the wavefront aberration is favorably corrected while changing the focal length.

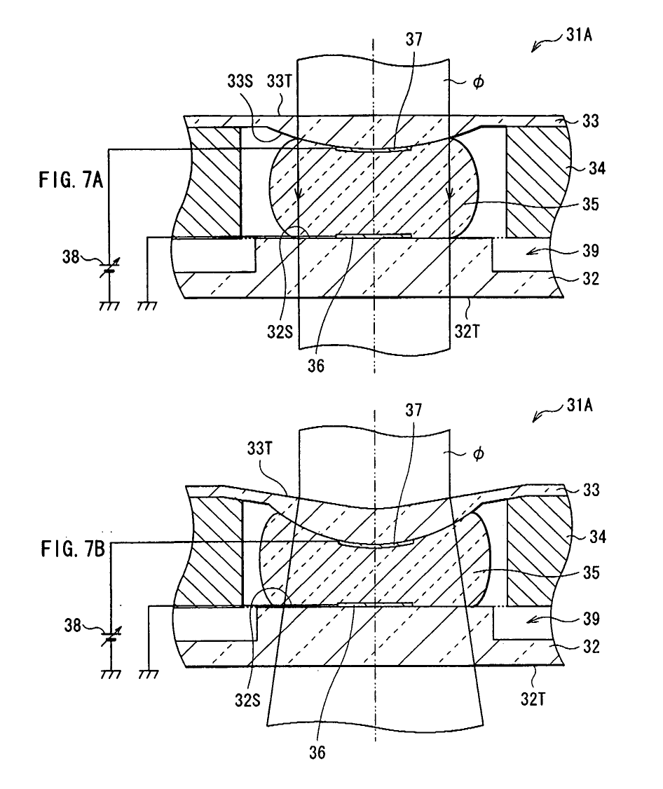

Moreover, not to exert the optical action when the voltage is not applied, and to obtain a negative refractive power when the voltage is applied, the following operation may be performed. FIG. 7A shows an initial state in which a voltage is not applied between the transparent electrode layers 36 and 37. At this time, the surface 33T as the entry side of the transparent deformation member 33 is substantially parallel to the surface 32T as the emission side of the transparent substrate 32. Therefore, the incident light flux φ passes through the variable focal-length lens 31 without being subjected to any optical action. In other words, in substance, the variable focal-length lens 31 only has the same action as a plate glass. On the other hand, FIG. 7B shows a state in which a predetermined voltage is applied between the transparent electrode layers 36 and 37. By the application of the voltage, an electrostatic force acts between the transparent electrode layers 36 and 37, and then the transparent deformation member 33 and the filling layer 35 are deformed so that the surface 33T becomes concave. At this time, the surface 32T is still flat. Therefore, in this case, the variable focal-length lens 31 acts as a concave lens, and exerts a function of dispersing the incident light flux φ. In this case, the transparent deformation member 33 has a predetermined thickness distribution (elastic-constant distribution), so when the applied voltage is adjusted, a desired concave shape can be selected. Therefore, the wavefront aberration is favorably corrected while changing the focal length.

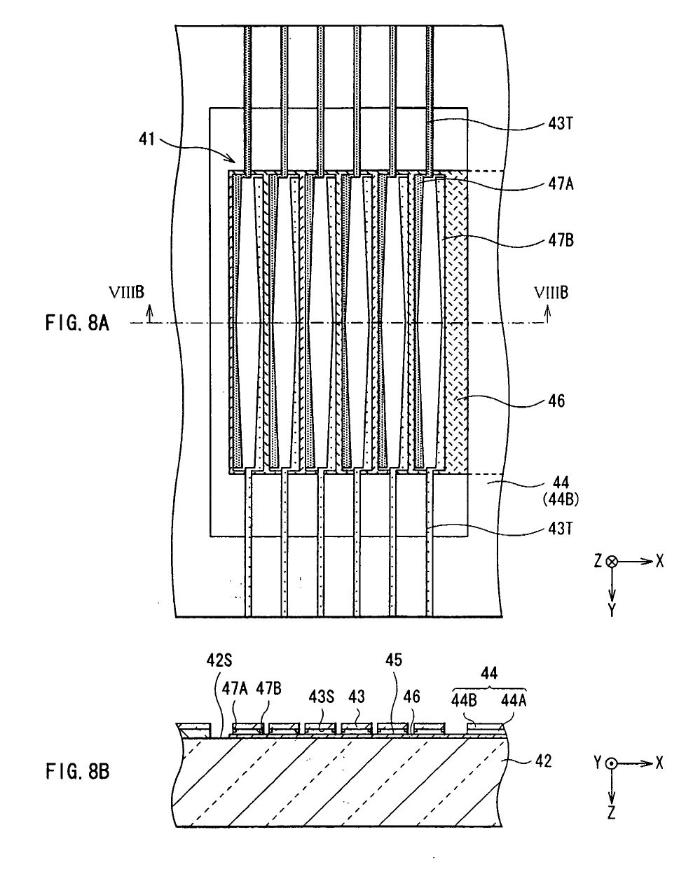

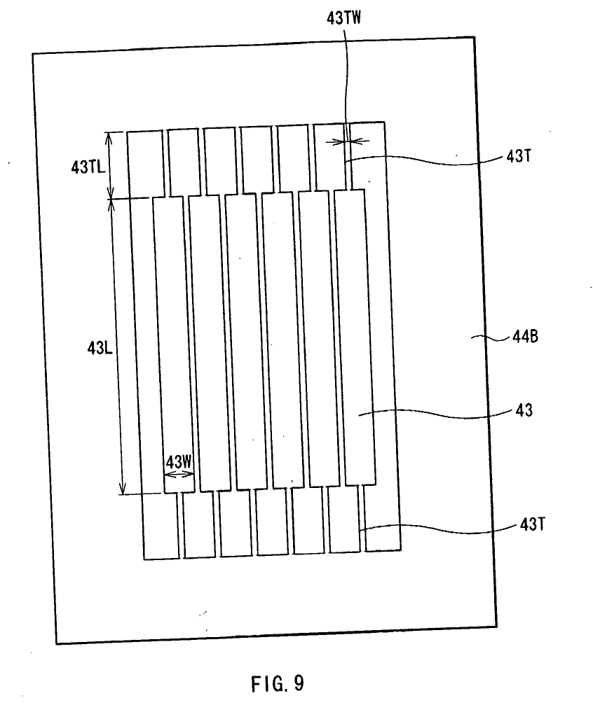

Next, the horizontal deflection section 4 and the vertical deflection section 5 will be described below referring to FIGS. 8A and 8B. FIG. 8A shows a plan view of the horizontal deflection section 4, and FIG. 8B shows a sectional view of the horizontal deflection section 4 taken along a line VIIB-VIIB of FIG. 8A as viewed from an arrow direction. The structure of the vertical deflection section 5 is the same as that of the horizontal deflection section 4 which will be described later, so the structure of the vertical deflection section 5 will not be described.

The horizontal deflection section 4 includes a plurality of light deflection devices 41 arranged in parallel to each other. In FIGS. 8A and 8B, 6 light deflection devices 41 are shown; however, the number of the light deflection devices may be increased or decreased if necessary. The light deflection device 41 is a transmissive deflection device, and includes a transparent substrate 42, a movable layer 43 which faces the transparent substrate 42, and is made of a transparent material, a filling layer 45 which is made of a transparent material and is filled between the transparent substrate 42 and the movable layer 43, a transparent electrode layer pattern 46 and transparent electrode layer patterns 47A and 47B. In this case, the transparent substrate 42 and the transparent electrode layer pattern 46 are commonly arranged for the plurality of light deflection devices 41.

The transparent substrate 42 is made of, for example, a transparent material with high rigidity such as quartz. In a central region of the transparent substrate 42, a strap-shaped laminate including the movable layer 43 and the filling layer 45 is arranged, and in a peripheral region around the central region, a support 44 as a laminate including a column 44A with substantially the same thickness as that of the filling layer 45 and a support frame 44B with substantially the same thickness as that of the movable layer 43 is arranged. The movable layer 43 is a parallel flat plate having high rigidity such as quartz, and is connected to the support frame 44B via a pair of hinges 43T connected to both ends of the movable layer 43 in a longitudinal direction. As shown in FIG. 9, the movable layer 43 has a structure integrally molded with the support frame 44B and the hinges 43T arranged around the movable layer 43. FIG. 9 is a plan view of the structures of the movable layer 43, the hinges 43T and the support frame 44B. In the movable layer 43, the length 43L is, for example, 1 mm, and the thickness 43W is, for example, 0.1 mm. One end of each of the pair of hinges 43T is connected to an end portion of the movable layer 43, and the other end is connected to the support frame 44B, so the pair of hinges 43T are formed so as to be positioned on the same straight line. Each hinge 43T has a long narrow shape along the longitudinal direction of the movable layer 43, and has, for example, a length 43TL of 0.2 mm and a thickness 43TW of 0.01 mm. Therefore, when some external forces are applied, the movable layer 43 is rotatable around a rotation axis along a direction where the hinge 43T extends. In this case, the filling layer 45 is made of, for example, a transparent and extremely flexible fluid material such as silicone, so the filling layer 45 does not prevent the rotation of the movable layer 43.

The rotation of the movable layer 43 is performed through the use of an electrostatic force generated by applying a voltage between the transparent electrode layer pattern 46 and the transparent electrode layer patterns 47A and 47B. The transparent electrode layer pattern 46 is arranged so as to be laid over at least a region corresponding to the movable layer 43 in the surface 42S of the transparent substrate 42, and is grounded by a connecting line (not shown). On the other hand, the transparent electrode layer patterns 47A and 47B are formed on the surface 43S of the movable layer 43 so as to face the transparent electrode layer pattern 46, and extend along the hinge 43T to be connected to external control power sources 48A and 48B (which will be described later), respectively. Therefore, each of the transparent electrode layer patterns 47A and 47B is paired with the transparent electrode layer pattern 46 so as to generate an electrostatic force between them by the application of a voltage. Moreover, the transparent electrode layer patterns 47A and 47B face each other in edges extending in a longitudinal direction (a Y-axis direction) in the movable layer 43, and are formed to have a width gradually expanding from a central position to both end portions in a longitudinal direction in the movable layer 43 so that they have the same shape. The transparent electrode layer pattern 46 and the transparent electrode layer patterns 47A and 47B are formed through directly depositing, for example, a conductive material such as carbon or ITO on the surfaces 42S and 43S by a typical vacuum film formation apparatus such as a vacuum deposition apparatus, a sputtering apparatus, an ion plating apparatus or a CVD apparatus. In FIG. 8A, to facilitate understanding, patterns are put on parts where the transparent electrode layer patterns 47A and 47B are formed, and the outlines of the parts are shown by solid lines. Further, in the embodiment, the transparent electrode layer pattern 46 is commonly arranged on the surface 42S of the transparent electrode 42; however, the transparent electrode layer pattern 46 may be separately arranged on the surface 43S of each movable layer 43. In this case, the transparent electrode layer patterns 47A and 47B may be arranged on the surface 42S. Moreover, in the embodiment, the transparent electrode layer pattern 46 is commonly arranged on both of the transparent electrode layer patterns 47A and 47B; however, the transparent electrode layer pattern 46 may be divided into a plurality of parts so that each of the parts are arranged so as to correspond to each of the transparent electrode layer patterns 47A and 47B.

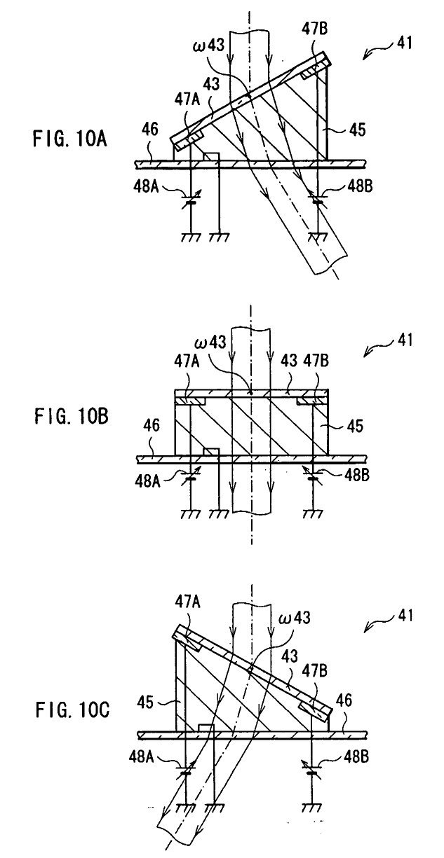

Referring to FIGS. 10A through 10C, the operation of the light deflection device 41 will be described in detail below. FIGS. 10A through 10C are schematic views for describing the operation and optical action of the light deflection device 41. In the light deflection device 41, when a voltage with a predetermined magnitude is applied between the transparent electrode layer pattern 46 and the transparent electrode layer patterns 47A and 47B by the external control power sources 48A and 48B, an electric-field-intensity distribution is formed in a direction along an X axis. For example, when a voltage is applied between the transparent electrode layer pattern 46 and the transparent electrode layer pattern 47A to generate an electrostatic force, and a voltage is not applied between the transparent electrode layer pattern 46 and the transparent electrode layer pattern 47B, torque is produced around a central axis ω43 of a pair of hinges 43T as a rotation axis, and the movable layer 43 rotates in a direction where the transparent electrode layer pattern 46 and the transparent electrode layer pattern 47A attract each other. At this time, the hinges 43T are twisted. When the application of a voltage between the transparent electrode layer pattern 46 and the transparent electrode layer pattern 47A is stopped in the state shown in FIG. 10A, an electrostatic force is lost, and the movable layer 43 becomes parallel to the transparent electrode layer pattern 46 (that is, the transparent substrate 42) by the resilience of the hinges 43T (refer to FIG. 10B). Moreover, when a voltage is not applied between the transparent electrode layer pattern 46 and the transparent electrode layer pattern 47A, and a voltage is applied between the transparent electrode layer pattern 46 and the transparent electrode layer pattern 47B to generate an electrostatic force, the movable layer 43 rotates in a direction where the transparent electrode layer pattern 46 and the transparent electrode layer pattern 47B attract each other (refer to FIG. 10C). In this case, when the magnitude of the applied voltage is adjusted, the rotation angle of the movable layer 43 can be controlled. In other words, a rotation angle between FIGS. 10A and 10B, or a rotation angle between FIGS. 10B and 10C can be achieved.

Next, the optical action of the light deflection device 41 will be described below. The case where a light flux enters from the movable layer 43 is considered here. In FIG. 10A, the movable layer 43 is inclined down to the left with respect to the incident light flux. In general, each material of the light deflection device 41 has a larger refractive index than air, so the light flux entering the movable layer 43 is refracted to the right. After that, the light flux passing through the filling layer 45, the transparent electrode layer pattern 46 and the transparent substrate 42 in order is further refracted to the right when the light flux is emitted to outside. As a result, the incident light is deflected to the right. The deflection angle at this time depends on the rotation angle (inclination angle) of the movable layer 43. In other words, it depends on the magnitude of a voltage applied between the transparent electrode layer pattern 46 and the transparent electrode layer pattern 47A. Moreover, when the refractive index of each material of the light deflection device 41 is appropriately selected, the deflection angle is adjusted. For example, in the case where the filling layer 45 has a refractive index n45 which is twice as large as the refractive index n43 of the movable layer 43 (=2×n43), a deflection angle which is twice as large as the rotation angle of the movable layer 43 can be obtained. On the other hand, in FIG. 10C, the movable layer 43 is inclined down to the right with respect to the incident light flux, so the light flux is refracted to the left which is opposite to the case of FIG. 10A. The deflection angle is adjusted as in the case of FIG. 10A. Thus, the light deflection device 41 can obtain an action as a prism. Moreover, in the state shown in FIG. 10B, the incident light flux is not subjected to any deflection action, so the incident light flux travels in a straight line. In FIGS. 10A through 10C, the transparent substrate 42 is not shown, so it is shown that the light flux is emitted from the bottom surface of the transparent electrode layer pattern 46; however, actually the light flux is emitted from the bottom surface of the transparent substrate 42.

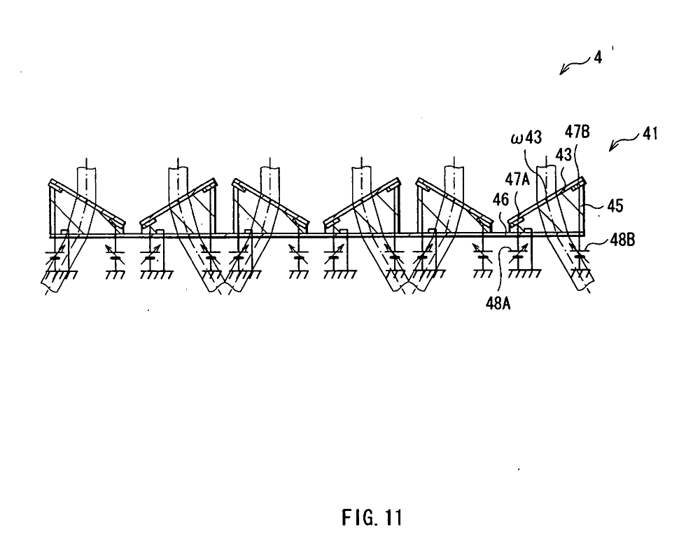

The light deflection device 41 exerting such an optical action can separately select the rotation angle of the movable layer 43 by separately controlling an applied voltage. Therefore, as shown in FIG. 11, each light deflection device 41 constituting the horizontal deflection section 4 can deflect the incident light flux at a desired angle.

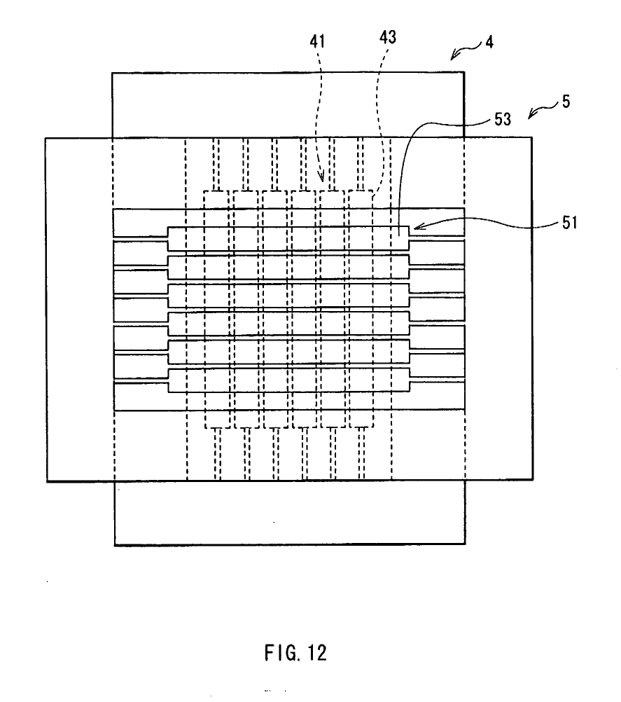

The vertical deflection section 5 includes a plurality of light deflection devices 51 with the same structure as that of the light deflection device 41 in the horizontal deflection section 4. As shown in FIG. 12, the light deflection devices 41 and 51 are arranged so that the movable layers 43 and 53 are arranged so as to orthogonally overlap each other. Through the use of such a structure, deflection in both horizontal and vertical directions which is difficult for a reflective light deflection device in a related art to achieve can be easily performed.

<Action of Three-Dimensional Display>

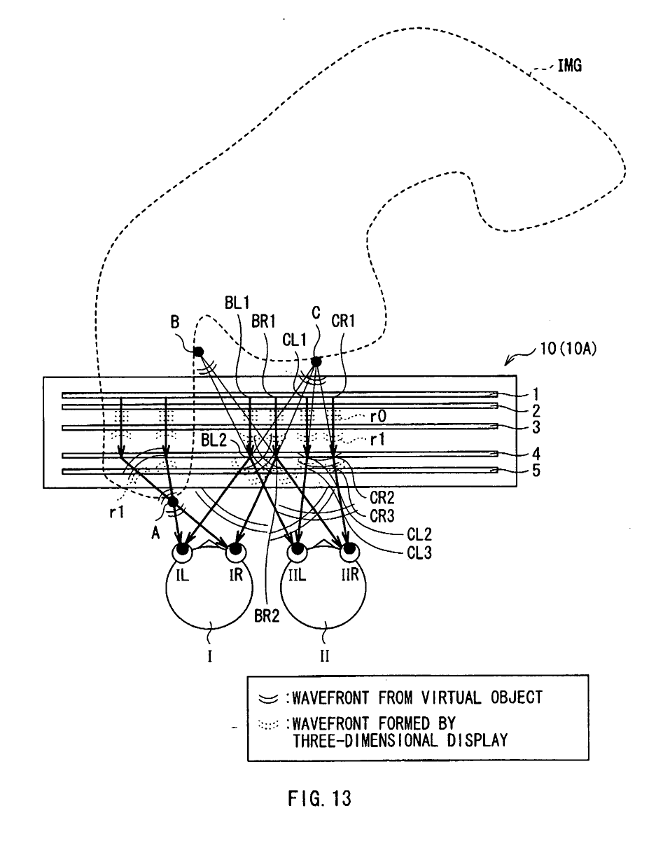

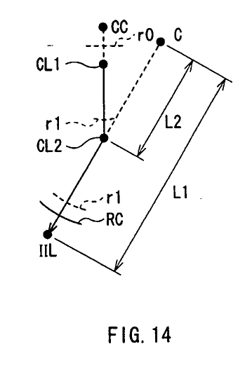

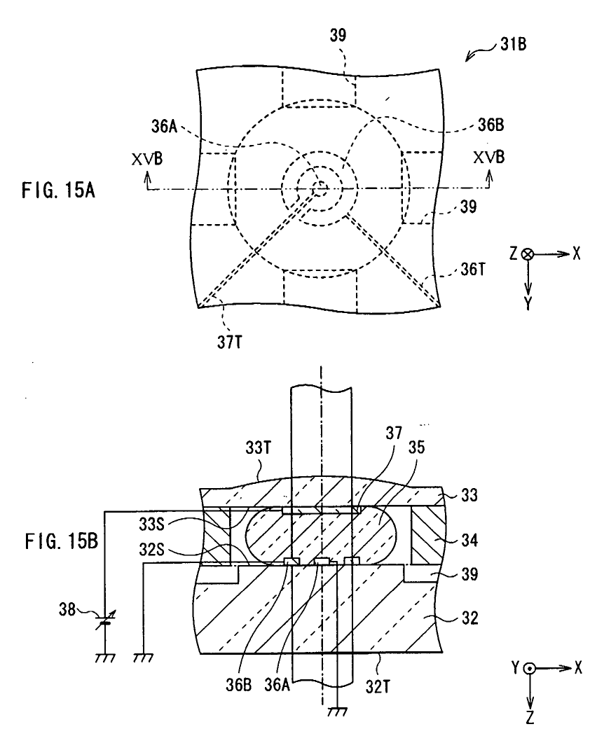

Next, the action of the three-dimensional display 10A will be described below referring to FIGS. 13 and 14.

In general, when a viewer observes an object point on an object, the viewer observes a spherical wave emitted from the object point as a point light source, thereby the object point is perceived as “a point” which exists in a specific position in three-dimensional space. In general, in nature, wavefronts emitted from an object travels at the same time, and the wavefronts with a certain wavefront shape always continuously reach the viewer. However, under the present circumstances, except for holography, it is difficult to concurrently and continuously recreate the wavefront of a light wave in each point in space. However, even if there is a virtual object, and a light wave is emitted from each point of the virtual object, and the time when each light wave reaches the viewer is inaccurate to some extent, or the light waves do not reach continuously and reach as intermittent light signals, since human eyes have an integration effect, the virtual object can be observed without any unnatural feeling. In the three-dimensional display 10A according to the embodiment, a wavefront from each point in space is formed at high speed in time sequence through the use of the integration effect of human eyes, thereby a more natural three-dimensional image than that in a related art can be generated.

FIG. 13 is a conceptual diagram showing a state where viewers I and II observes a virtual object IMG as a stereoscopic image through the use of the three-dimensional display 10A. The principle of operation of the three-dimensional display 10A will be described below.

For example, the image light wave of an arbitrary virtual object point (for example, a virtual object point B) in the virtual object IMG is formed as below. At first, two kinds of images for the right eye and the left eye of the viewer is displayed on the two-dimensional display section 1. It is difficult to display two images at the same time, so the images are displayed in order, and are finally sent to the right and left eyes in order. For example, images corresponding to a virtual object point C are displayed at a point CL1 (for the left eye) and a point CR1 (for the right eye) in the two-dimensional display section 1, and pass through the collimation section 2, the lens array 3, the horizontal deflection section 4 and the vertical deflection section 5 in order, and then reach the left eye IIL and the right eye IIR of the viewer II. Likewise, images corresponding to the virtual object point C for the viewer I are displayed at a point BL1 (for the left eye) and a point BR1 (for the right eye) in the two-dimensional display section 1, and pass through the collimation section 2, the lens array 3, the horizontal deflection section 4 and the vertical deflection section 5 in order, and then reach the left eye IL and the right eye IR of the viewer I. The operation is performed in a time constant of the integration effect of human eyes at high speed, so the viewers I and II can perceive the virtual object point C without perceiving that the images are sent in order.

Display image light emitted from the two-dimensional display section 1 is generally converted into a parallel light flux in the collimation section 2, and then the parallel light flux travels toward the lens array 3. In the collimation section 2, the display image light is converted into a parallel light flux, and the focal length reaches an infinite value, thereby information obtained from a physiological function generated when the focal length of the eye is adjusted in position information of a point where a light wave is emitted is eliminated once. In FIG. 13, the wavefront of a light flux traveling from the collimation section 2 to the lens array 3 is shown as a parallel wavefront rO orthogonal to a traveling direction. Thereby, confusion in the brain caused by a mismatch between information from binocular parallax and a convergence angle and information from the focal length in a related art is relieved to some extent. After that, in the lens array 3, focal length information for each pixel is added. This will be described in detail later.

After the display image lights emitted from the points CL1 and CR1 in the two-dimensional display section 1 pass through the lens array 3, the display image lights reach points CL2 and CR2 in the horizontal deflection section 4. After the light waves reaching the points CL2 and CR2 in the horizontal deflection section 4 are deflected in a predetermined direction in a horizontal plane, the light waves reach points CL3 and CR3 in the vertical deflection section 5. Moreover, the light waves are deflected in a predetermined direction in a vertical plane by the vertical deflection section 5, and are emitted toward the left eye IIL and the right eye IIR of the viewer II. In this case, for example, the two-dimensional display section 1 sends the display image light in syncronization with the deflection angles by the horizontal deflection section 4 and the vertical deflection section 5 so that when the deflection angle is oriented to the left eye IIL of the viewer II, the wavefront of the display image light reaches the point CL3, and when the deflection angle is oriented to the right eye IIR of the viewer II, the wavefront of the display image light reaches the point CR3. At this time, the lens array 3 converts the wavefront in syncronization with the deflection angles by the horizontal deflection section 4 and the vertical deflection section 5. When the wavefronts of the display image lights emitted from the vertical deflection section 5 reach the left eye IIL and the right eye IIR of the viewer II, the viewer II can perceive the virtual object point C on the virtual object IMG as one point in three-dimensional space. Likewise, in the case of the virtual object point B, display image lights emitted from points BL1 and BR1 in the two-dimensional display section 1 pass through the lens array 3, and then the display image lights reach point BL2 and BR2 in the horizontal deflection section 4. After the light waves reaching the point BL2 and BR2 are deflected in a predetermined direction in a horizontal plane, the light waves are deflected in a predetermined direction in a vertical plane by the vertical deflection section 5, and then the light waves are emitted toward the left eye IIL and the right eye IIR of the viewer II. FIG. 13 shows a state in which images of the vertical object point C for the viewer I and images of the vertical object point B for the viewer II are displayed in the points BL1 and BR1 in the two-dimensional display section 1; however, they are displayed not at the same time but at different times.

Now, the action of the lens array 3 will be described referring to FIG. 14 in addition to FIG. 13. In the lens array 3, the wavefront r0 of the display image light emitted from the two-dimensional display section 1 is converted into a wavefront r1 having a curvature which allows the display image light to focus upon a focal point where an optical path length from an observation point to the focal point is equal to an optical path length from the observation point to a virtual object point. For example, as shown in FIG. 14, in the case where the wavefront RC of light emitted from the virtual object point C as a light source reaches the left eye IIL via the optical path length L1, the wavefront is formed so that the curvatures of the wavefront RC and the wavefront r1 in the left eye IIL coincide with each other. In this case, it can be considered that a focal point CC corresponding to the wavefront r1 is located at a distance equal to the optical path length L2 from the point CL2 to the virtual object point C on a straight line connecting the point CL2 and the point CL1. Providing that the display image light having the wavefront r1 is emitted from the focal point CC as a light source, when the wavefront r1 of the display image light reaches the left eye IIL, it is perceived as if the wavefront r1 is a wavefront RC emitted from the virtual object point C as a light source. Moreover, as shown in FIG. 13, in the case where a virtual object point A is located in a position nearer the viewer than the vertical deflection section 5, the wavefront r1 converted by the lens array 3 focuses on the virtual object point A.

As a result, confusion in the brain caused by a mismatch between the information from binocular parallax and a convergence angle and information from the focal length in the related art is completely eliminated.

Moreover, when the display image light emitted from the two-dimensional display section 1 is converted into a parallel light flux in the collimation section 2, the following action can be obtained. To secure binocular parallax, it is necessary to send two kinds of images for the right eye and the left eye. In other words, display image light for the right eye and display image light for the left eye are not supposed to enter the other eye. If the collimation section 2 is not included, and a spherical wave is emitted from the two-dimensional display section 1 as a light source, even though the spherical wave is deflected by the horizontal deflection section 4 or the vertical deflection section 5, unnecessary display image light enters the other eye. In this case, binocular parallax does not occur, and the viewer perceives a double image. Therefore, as in the case of the embodiment, when the display image light from the two-dimensional display section 1 is converted into a parallel light flux in the collimation section 2, the display image light does not spread in a fan-like form, so the display image light can reach a target eye without entering the other eye.

Thus, in the three-dimensional display 10A according to the embodiment, two-dimensional image light based on an image signal is generated by the two-dimensional display section 1, and the wavefront r0 of the display image light emitted from the two-dimensional display section 1 is converted into the wavefront r1 having a curvature. The curvature of the wavefront r1 at just after the point CL1 allows the display image light to focus upon the focal point CC where an optical path length from an observation point (the left eye IIL) to the focal point CC is equal to the optical path length L1 from the observation point (the left eye IIL) to the virtual object point C by the lens array 3. Therefore, the display image light includes not only information about binocular parallax, a convergence angle and motion parallax but also information about an appropriate focal length. Therefore, the viewer can ensure consistency between the information about binocular parallax, a convergence angle and motion parallax and information about an appropriate focal length, and a desired stereoscopic image can be perceived without physiological discomfort. In particular, in addition to deflection in a horizontal plane by the horizontal deflection section 4, deflection in a vertical plane by the vertical deflection section 5 is performed, so even in the case where a virtual line connecting both eyes of the viewer is shifted from a horizontal direction (in the case where the viewer lies down), predetermined images reach the right eye and the left eye, so the viewer can view a stereoscopic image.

As the lens array 3, a lens array 3A including a plurality of variable focal-length lenses 31 is used, so the following effect can be obtained. Each variable focal-length lens 31 includes the transparent substrate 32 and the transparent deformation member 33 which face each other, the filling layer 35 filled between them, and the transparent electrode layers 36 and 37 which are disposed on the surface 32S of the transparent substrate 32 and the surface 33S of the transparent deformation member 33, respectively, and the transparent deformation member 33 has an elastic-constant distribution determined by the thickness distribution in a direction along a layer plane, so when a voltage is applied between the transparent electrode layers 36 and 37 to deform the transparent deformation member 33 according to the elastic-constant distribution, the focal length can be changed while securing a desired aspherical shape with high precision. Therefore, even though the structure is simple and compact, the focal length can be changed while securing a good aberration performance.

Moreover, in the horizontal deflection section 4 and the vertical deflection section 5, transmissive light deflection devices 41 and 51 each including the transparent substrate 42 and the movable layer 43 which face each other, the filling layer 45 filled between them, and the transparent electrode layer pattern 46 and the transparent electrode layer patterns 47A and 47B which are disposed on the surface 42S of the transparent substrate 42 and the surface 43S of the movable layer 43 and form an electric-field-intensity distribution in a direction along a layer plane is used, so compared to the case where reflective light deflection devices are used, the whole structure is sufficiently compact, and deflection in a horizontal direction and a vertical direction can be easily performed.

Further, transmissive devices are used in all of the lens array 3, the horizontal deflection section 4 and the vertical deflection section 5, so a reduction in the size (the profile) of the whole three-dimensional display 10A can be achieved extremely easily.

<Modifications of Variable Focal-Length Lens>

Next, modifications of the embodiment will be described below. In the embodiment, the transparent deformation member 33 in the variable focal-length lens 31 has a thickness distribution, and a desired lens shape is formed through the use of an elastic-constant distribution determined by the thickness distribution. On the other hand, for example, variable focal-length lenses 31B, 31C and 31D as first, second and third modifications (Modifications 1 through 3) shown in FIGS. 15A and 15B through 17A and 17B have an electric-field-intensity distribution in a direction along a lamination plane, and a desired lens shape can be formed through the use of the electric-field-intensity distribution.

At first, the variable focal-length lens 31B as Modification 1 will be described below. FIG. 15A shows a plan view of the variable focal-length lens 31B, and FIG. 15B shows a sectional view of the variable focal-length lens 31B. FIG. 15B is a sectional view taken along a line XVB-XVB of FIG. 15A as viewed from an arrow direction. The variable focal-length lens 31B includes a transparent electrode layer pattern 36A having a circular shape in a central position on the surface 32S and a ring-shaped transparent electrode layer pattern 36B having the same center as the transparent electrode layer pattern 36A. The transparent electrode layer patterns 36A and 36B are isolated from each other, and are grounded. The variable focal-length lens 31B has the same structure as the variable focal-length lens 31 shown in FIGS. 5A and 5B except for the above-described points.

In the variable focal-length lens 31B, a voltage can be applied to the transparent electrode layer pattern 36A and the transparent electrode layer pattern 36B individually, so when each applied voltage is controlled, the shape of the transparent deformation member 33 can be controlled. For example, in the case where a state where the variable focal-length lens 31B is deformed from a state where the variable focal-length lens 31B functions as a convex lens to a state where the variable focal-length lens 31B functions as a concave lens, a voltage is applied to only an electrode of the transparent electrode layer pattern 36A located in the central position. Moreover, when a balance between a voltage applied to the transparent electrode layer pattern 36A and a voltage applied to the transparent electrode layer pattern 36B located so as to encircle the transparent electrode layer pattern 36A is adjusted, the transparent deformation member 33 can be deformed so as to have a desired aspherical surface. In this example, only a transparent electrode layer on the transparent substrate 32 side is divided, and the transparent electrode layer 37 on the transparent deformation member 33 side is not divided; however, the transparent electrode layer 37 may be divided so as to match the shapes of the transparent electrode layer patterns 36A and 36B. Alternatively, only the transparent electrode layer 37 on the transparent deformation member 33 side may be divided into a plurality of parts.

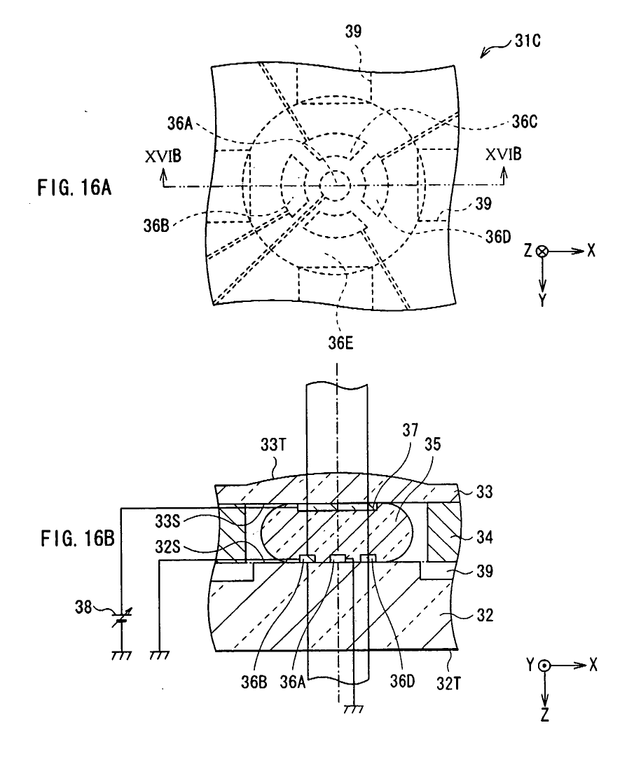

Next, the variable focal-length lens 31C as Modification 2 will be described below. FIG. 16A shows a plan view of the variable focal-length lens 31C, and FIG. 16B shows a sectional view of the variable focal-length lens 31C. FIG. 16B shows a sectional view taken along a line XVIB-XVIB of FIG. 16A as viewed from an arrow direction. The variable focal-length lens 31C includes transparent electrode layer patterns 36B through 36E evenly arranged on the surface 32S so as to encircle the transparent electrode layer pattern 36A. The transparent electrode layer patterns 36B through 36E are isolated from one another, and are grounded. The variable focal-length lens 31C has the same structure as that of the variable focal-length lens 31 shown in FIGS. 5A and 5B except for the above-described points. The transparent deformation member 33 can be asymmetrically deformed through the use of the transparent electrode layer patterns 36B through 36E arranged in such a manner. Therefore, the variable focal-length lens 31C is suitable for correcting, for example, coma aberration or the like.

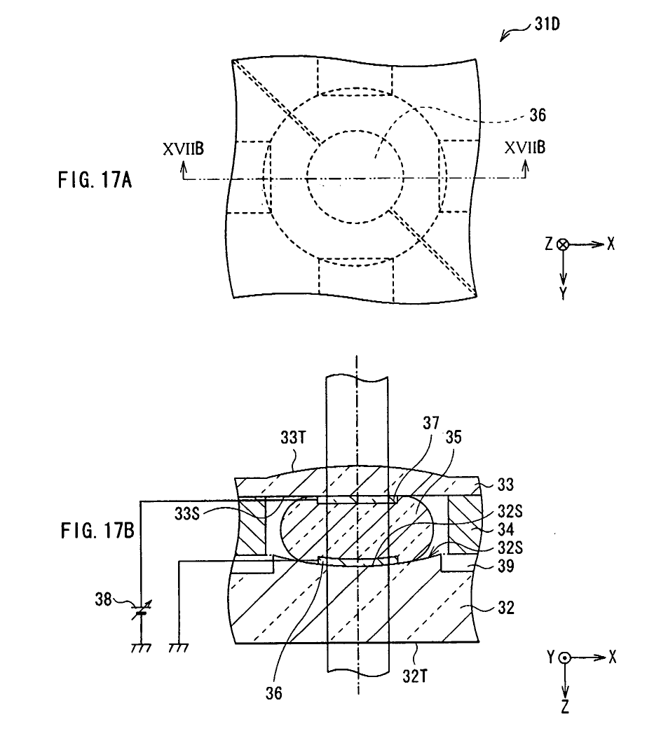

Next, the variable focal-length lens 31D as Modification 3 will be described below. FIG. 17A shows a plan view of the variable focal-length lens 31D, and FIG. 17B shows a sectional view of the variable focal-length lens 31D. FIG. 17B is a sectional view taken along a line XVIIB-XVIIB of FIG. 17A as viewed from an arrow direction. In the variable focal-length lens 31D, the surface 32S of the transparent substrate 32 is not flat but curved (in this case, concave). Therefore, the transparent electrode layer pattern 36 formed on the surface 32S is curved, so a relative distance between the transparent electrode layer pattern 36 and the transparent electrode layer pattern 37 which face each other has a distribution. Thereby, an attractive force by an electrostatic force is weaker in a central portion, and an attractive force is relatively strong in a peripheral portion. A desired aspherical shape can be formed through the use of this magnitude distribution. Also in this case, at least one of the transparent electrode layer patterns 36 and 37 may be divided.

### Second Embodiment

Next, a three-dimensional display 10B according to a second embodiment of the invention will be described below. In the first embodiment, the variable focal-length lens is used as a wavefront conversion means. In the embodiment, a variable focal-length mirror is used.

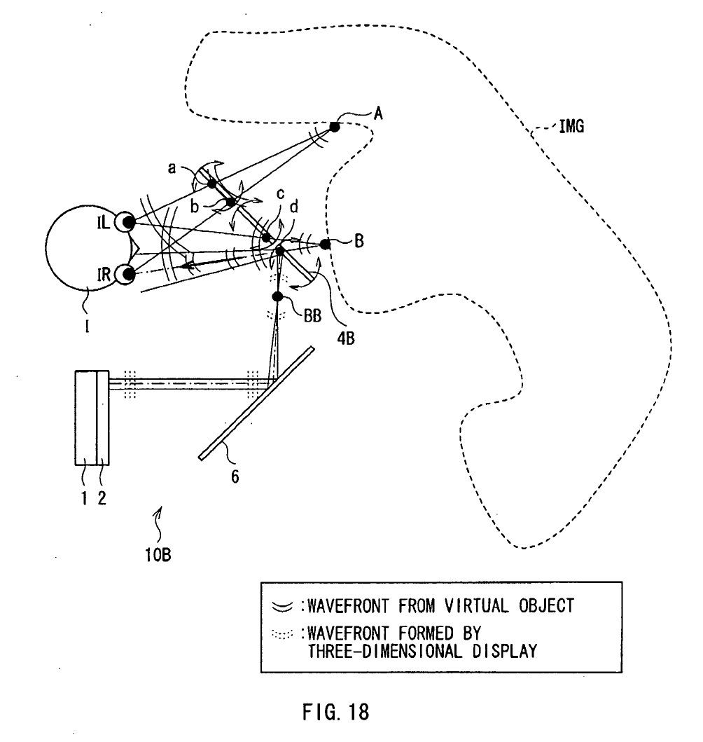

FIG. 18 is a conceptual diagram for describing the whole structure of the three-dimensional display 10B. As shown in FIG. 18, the three-dimensional display 10B includes the two-dimensional display section 1, the collimation section 2, a mirror array 6 as a wavefront conversion means and a deflecting mirror 4B as a deflection means in order.

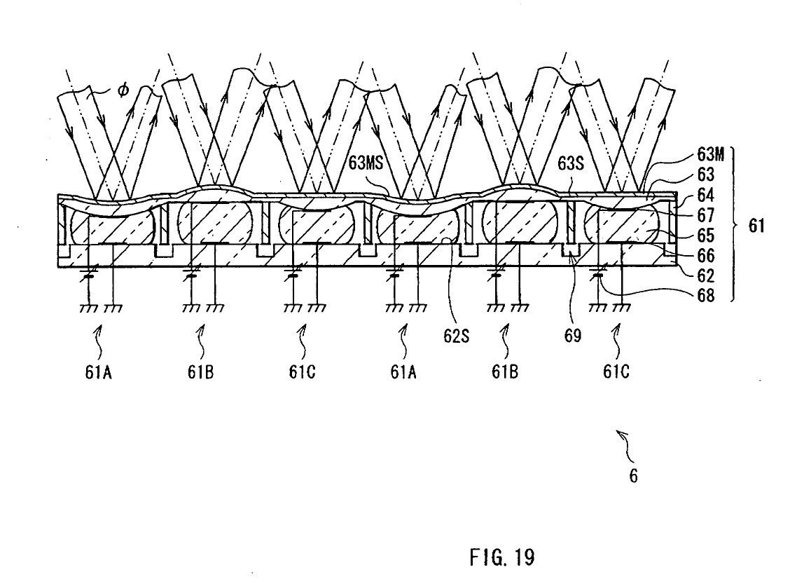

The mirror array 6 includes a plurality of variable focal-length mirrors 61 as shown in FIG. 19. FIG. 19 shows a schematic sectional view of the mirror array 6. As in the case of the variable focal-length lens 31, the variable focal-length mirror 61 is an optical device capable of freely changing its focal length by deforming a part of the variable focal-length mirror 61. Each variable focal-length mirror 61 includes a substrate 62 as a rigid layer, a reflective deformation member 63 as an elastic layer facing the substrate 62, a column 64 arranged between the substrate 62 and the reflective deformation member 63, electrode layers 66 and 67 which are formed on a surface of the substrate 62 and a surface of the reflective deformation member 63, respectively and face each other, and a filling layer 65 filled between the electrode layers 66 and 67. The electrode layer 66 is grounded, and the electrode layer 67 is connected to an external control power source 68. Moreover, a continuous hole 69 is arranged in a part of the column 64 so that ventilation to outside can be provided.

The substrate 62 is made of, for example, a material with high rigidity such as quartz. The column 64 is formed of a high rigid material as in the case of the substrate 62. The reflective deformation member 63 arranged on the substrate 62 so as to be supported by the column 64 is made of, for example, a polymer such as a flexible polyester material, and has a high elastic modulus. Moreover, on a surface 63S opposite to a surface closer to the substrate 62, a reflective film 63M of a thin film of silver (Ag) or the like, a protective film (not shown) protecting the reflective film 63M are laminated in order. The reflective film 63M is formed by, for example, a sputtering method, and an incident light flux φ is reflected on a reflective surface 63MS of the reflective film 63M. As the reflective deformation member 63 has a thickness which is gradually reduced from a central portion to a peripheral portion in a region where a parallel light flux φ from the collimation section 2 is reflected, the reflective deformation member 63 has a elastic-constant distribution in an in-plane direction where the reflective deformation member 63 extends. Moreover, in the case where the surface 63S is curved, the reflective deformation member 63 exerts a lens action. Such a reflective deformation member 63 can be molded by the same method as the method of molding the transparent deformation member 33.

The electrode layers 66 and 67 can have the same structures as those of the transparent electrode layers 36 and 37. However, the electrode layers 66 and 67 are not necessarily made of a transparent material.

The filling layer 65 is made of a material with the same properties as the filling layer 35 in the first embodiment (for example, silicone). The reflective deformation member 63 may be deformed through the use of an electrostatic force acting between the electrode layers 66 and 67 without arranging the filling layer 65. However, when the filling layer 65 is arranged, the dielectric constant between the electrode layers 66 and 67 is improved, and dielectric breakdown characteristics are stabilized, so a wavefront can be formed more efficiently and reliably.

In the variable focal-length mirror 61 with such a structure, while incident light is reflected, light is focused or dispersed. Alternatively, the parallel light flux can be only reflected in an as-is state without exerting such a lens action. More specifically, when a voltage with a predetermined magnitude is applied between the electrode layer 66 and the transparent electrode layer 67 by the external control power source 68, an electrostatic force is generated between the electrode layer 66 and the electrode layer 67, and they attract each other. The electrode layer 66 is fixed to the surface 62S of the substrate 62, and the electrode layer 67 is fixed to the surface 63S of the reflective deformation member 63, so as a result, the substrate 62 and the reflective deformation member 63 attract each other. At this time, substrate 62 is made of a material with relatively high rigidity, so the substrate 62 is hardly deformed. On the other hand, the reflective deformation member 63 is made of a material with high elasticity, so relatively large deformation of the reflective deformation member 63 occurs. The reflective deformation member 63 is deformed according to the elastic-constant distribution determined by its thickness distribution, so when the reflective deformation member 63 is designed and processed so as to have a desired shape after deformation, a desired lens action can be obtained. At this time, through the use of a change in the electrostatic force according to the magnitude of the voltage applied between the electrode layer 66 and the electrode layer 67, continuously (or gradually) different shapes of the reflective deformation member 63 are selected and formed. In FIG. 19, the variable focal-length mirror 61A has a concave reflective surface 63MS, and is in a state of exerting a light focusing action, and the variable focal-length mirror 61B has a convex reflective surface 63MS, and is in a state of exerting a dispersing action, and the variable focal-length mirror 61C having a flat reflective surface 63MS, and is in a state of only reflecting light without exerting the lens action. The thickness distribution of the reflective deformation member 63 can be optimized on the basis of, for example, a simulation result by a finite element method. Thereby, the variable focal-length mirror 61 capable of changing its focal length while maintaining a desired spherical or aspherical shape can be achieved.

As the deflecting mirror 4B, for example, a galvano mirror can be used. In FIG. 18, an example in which three galvano mirrors are arranged is shown; however, the number of galvano mirrors may be two or less, or four or more if necessary. Moreover, a scanning micromirror array device in which a large number of deflectable micromirrors are arranged such as a DMD (digital multimirror device) may be used.

Next, the operation principle in the case where the virtual object IMG as a stereoscopic image is observed through the use of the three-dimensional display 10B including such a mirror array 6 and such a deflecting mirror 4B will be described referring to FIGS. 18 and 19.

It is assumed that the wavefront of display image light corresponding to a virtual object point B of the virtual object when seen by the right eye IR of the viewer I is emitted from a specific display region of the two-dimensional display section 1 via the collimation section 2. The display image light is reflected by the variable focal-length mirror 61 of the mirror array 6, and at this time, the display image light is converted into a wavefront with a desired curvature through controlling the shape of the surface 63S (that is, a surface of the reflective film 63M). In this case, the display image light is converted into a wavefront with a curvature (a focal length) which the viewer perceives when the light wave generated in the virtual object point B (that is, a spherical wave emitted from the virtual object point B as a light source) reaches the viewer. In other words, the shape of the surface 63S may be controlled so that the optical path length from the virtual object point B to the right eye IR of the viewer I and the optical path length from the focal point BB of the display image light reflected by the mirror array 6 to the right eye IR of the viewer I match each other. When the deflecting mirror 4B is oriented to the right eye IR of the viewer I, the display image light reflected by the mirror array 6 reaches a point d on the deflecting mirror 4B and is reflected, and then enters the right eye IR. Likewise, when the wavefront of display image light corresponding to the virtual object point B when seen by the left eye IL of the viewer I is emitted from another specific display region in the two-dimensional display section 1, after the display image light passes through the mirror array 6, in the case where the deflecting mirror 4B is oriented to the left eye IL of the viewer I, the display image light reaches a point c on the deflecting mirror 4B and is reflected, and then enters the left eye IL.

Through the above steps, the viewer I observes the virtual object point B on the virtual object IMG with both eyes. At this time, the viewer I perceives the virtual object point B at an intersection point of a straight line connecting the left eye IL and the point c and a straight line connecting the right eye IR and the point d. Likewise, the viewer I perceives another virtual object point A on the virtual object IMG as one point in space at an intersection point of a straight line connecting the left eye IL and the point a and a straight line connecting the right eye IR and the point b. Moreover, any other virtual object points (not shown) can be perceived through the same steps.

Thus, in the three-dimensional display 10B according to the embodiment, the viewer can ensure consistency between information about binocular parallax, a convergence angle and motion parallax and information about an appropriate focal length, and a desired stereoscopic image can be perceived without physiological discomfort.

### EXAMPLE

Next, an example of the invention will be described below.

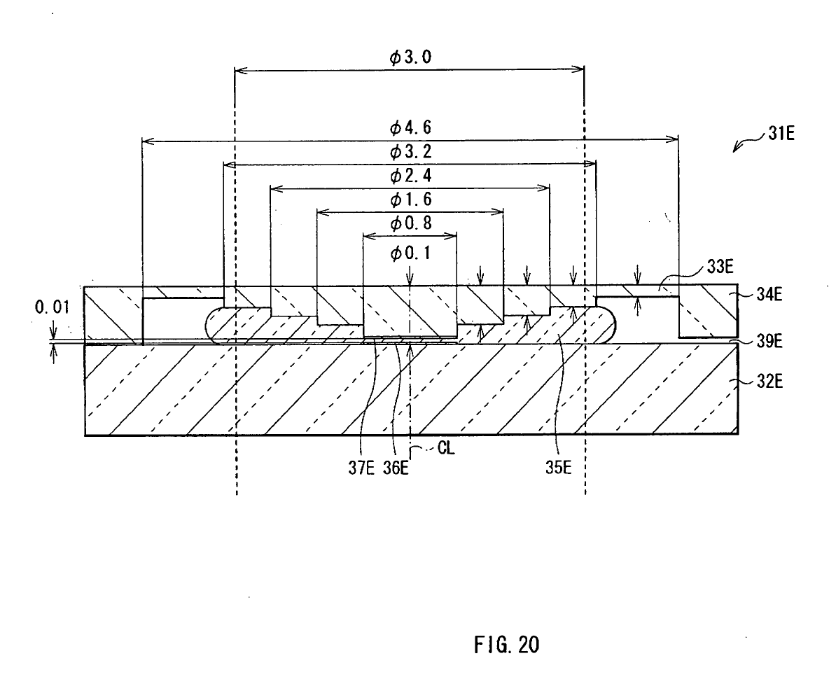

In the example, a variable focal-length lens 31E with a structure shown in FIG. 20 according to the invention was formed, and the characteristics of the variable focal-length lens 31E were evaluated.

As shown in FIG. 20, in the variable focal-length lens 31E as the example, a transparent deformation member 33E having a thickness gradually reduced from a central position CL and a column 34E were integrally molded. The transparent deformation member 33E had a circular plan shape having its center in the central position CL. Moreover, a space between a transparent electrode layer 36E and a transparent electrode layer 37E which were arranged in a central region in a thickness direction was 0.01 mm. The transparent electrode layers 36E and 37E were made of ITO, and were circular thin films with a diameter of 0.8 mm. A filling layer 35E was made of silicone. The filling layer 35E was formed through coating a desired region on a transparent electrode 42E with liquid silicone, bonding the transparent electrode 42E and the transparent deformation member 33E, and then thermally curing the liquid silicone at approximately 130° C. to change the liquid silicone in a rubbery state. As silicone was in a liquid state at first, so the filling layer 35E with as thin a thickness as 0.01 mm could be easily formed.

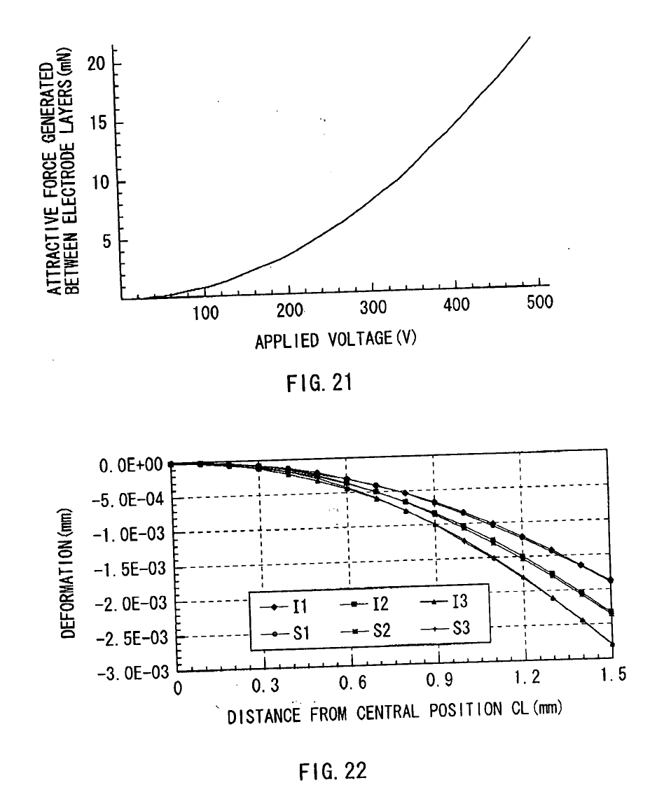

FIG. 21 is a plot showing a relationship between a voltage applied between the transparent electrode layer 36E and the transparent electrode layer 37E and an attractive force generated at the time. In FIG. 21, the horizontal axis indicates an applied voltage (V), and the vertical axis indicates an attractive force (mN) generated between the electrode layers. It was obvious from FIG. 21 that the attractive force was a value directly proportional to the square of the applied voltage. The attractive force was directly proportional to the sectional areas of the transparent electrode layers 36E and 37E, and was inversely proportional to the square of the distance between the transparent electrode layers 36E and 37E, so the attractive force could be adjusted by selecting them.

In a typical static actuator, air is filled between electrodes. On the other hand, in the example, a filling layer 35E made of silicone or the like was filled between the transparent electrode layer 36E and the transparent electrode layer 37E. For example, silicone had a relative dielectric constant of 3 to 10, so in the example, even if the same voltage was applied, an attractive force which was 3 to 10 times as large as the attractive force in the typical static actuator could be generated. Alternatively, even if a lower voltage was applied, a certain attractive force could be generated. Moreover, in the case where air is filled between the electrodes, the breakdown voltage is as low as approximately 1 kv/mm, so it is difficult to apply a too high voltage; therefore, it is considered that in general, in the static actuator, it is difficult to obtain a large attractive force. However, it was confirmed that when silicone was used as the filling layer 35E like the example, a breakdown voltage of approximately 300 kV/mm could be obtained at a distance of approximately 0.01 mm between the electrodes. Therefore, in the variable focal-length lens according to the invention, compared to the typical static actuator, a larger voltage could be applied, and an extremely large attractive force could be generated. It was obvious from FIG. 21 that in the example, even if the applied voltage (500 V) was equal to or less than the breakdown voltage, a large attractive force up to 20 mN could be obtained.

The transparent deformation member 33E shown in FIG. 20 had a sectional shape for achieving ideal aspherical shapes I1 through I3 shown in FIG. 22. The sectional shape was determined by computer simulation through the use of a method such as a finite element method; however, the shape may be actually formed and matched. In FIG. 22, the horizontal axis indicates a distance (mm) from the central position CL, and the vertical axis indicates deformation (mm). The ideal aspherical shape I1 represents the case where an attractive force of 10.9 mN was generated between the transparent electrode layers 36E and 37E, and the ideal aspherical shape I2 represents to the case where an attractive force of 13.4 mN was generated between the transparent electrode layers 36E and 37E, and the ideal aspherical shape I3 represents the case where an attractive force of 16.0 mN was generated between the transparent electrode layers 36E and 37E. The ideal aspherical shapes I1 through I3 substantially matched values S1 to S3 calculated by the computer simulation by the finite element method.

Although the invention is described referring to the embodiments and the example, the invention is not specifically limited to them, and can be variously modified. For example, in the above embodiments, the case where the liquid crystal device is used as a display device is described as an example; however, the display device is not limited to the liquid crystal device. For example, self-luminous devices such as organic EL devices, plasma light-emitting devices, field emission display (FED) devices, light-emitting diodes (LEDs) arranged into an array can be used as a display device. In the case where such a self-luminous display device is used, it is not necessary to arrange a light source for backlight, so a simpler structure can be achieved. Moreover, the liquid crystal device described in the above embodiments functions as a transmissive light valve; however, a reflective light valve such as a GLV (grating light valve) or a DMD (digital multimirror) can be used as a display device. Further, in the above embodiments, to facilitate understanding, the case where the two-dimensional image generating means, the light collimation means, the wavefront conversion means and the deflection means are clearly separated is described as an example; however, the invention is not limited to this. More specifically, the invention is not limited to the case where the above means are physically separated, and- the above means may be conceptually included.

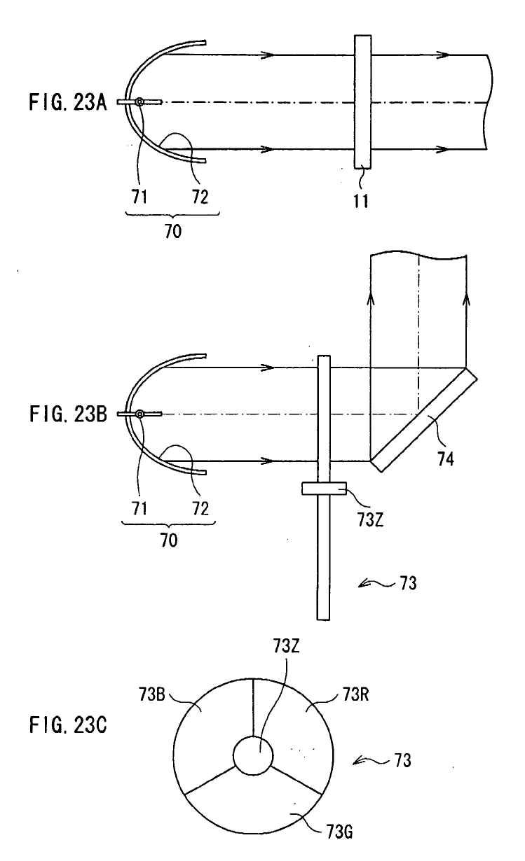

Moreover, in the case where the wavefront shape of light from the light source is known (for example, the case where it is clearly a plane wave or a spherical wave), the wavefront may not be converted into a plane wave. For example, as shown in structural examples (which will be described later) shown in FIGS. 23A through 27, in the case where a backlight which has high parallelism and is a close equivalent of a plane wave is used, the light collimation means (collimation section) may not be used. Further, when the area of a light-emitting region in each light-emitting pixel is extremely small in the case where the self-luminous device is used, in general, light from the self-luminous device can be considered to be a spherical wave, so the light collimation means (collimation: section) may not be used. In the case where the wavefront shape of light is known in such a manner, when the wavefront conversion means (such as the variable focal-length lens or the variable focal-length mirror) is controlled according to the wavefront shape, a desired wavefront lo can be formed, so information about binocular parallax, a convergence angle, motion parallax and the focal length can be correctly obtained without using the light collimation means. Next, other structural examples of the two-dimensional image generating means and the light collimation means will be described below referring to FIGS. 23A through 27.

FIG. 23A shows a structural example (Modification 4) in which a liquid crystal device 11 is used as a section generating a two-dimensional image, and a lamp 70 such as a halogen lamp, a metal halid lamp, a super high pressure mercury lamp or a xenon lamp is used as a light source for the backlight BL. The lamp 70 includes a light-emitting source 71 and a mirror 72. When the positions or shapes of the light source 71 and the mirror 72 are adjusted, light emitted from the lamp 70 becomes substantially parallel light. It is desirable to use the closest possible equivalent of a point light source, and it is desirable that the mirror 72 has a parabolic shape.

FIG. 23B shows a structural example (Modification 5) in which the above-described lamp 70 is used as a light source, and a deflectable micromirror such as a DMD is used as a section generating a two-dimensional image. After the parallel light from the lamp 70 passes through a color wheel 73, the parallel light is reflected by a micromirror array 74 in which a large number of the above reflectable micromirrors are arranged, and is emitted to a predetermined direction as a two-dimensional image. As shown in FIG. 23C, in the color wheel 73, a red region 73R, a green region 73G and a blue region 73B are arranged around a rotation axis 73Z, and the color wheel 73 rotates about the rotation axis 73Z.

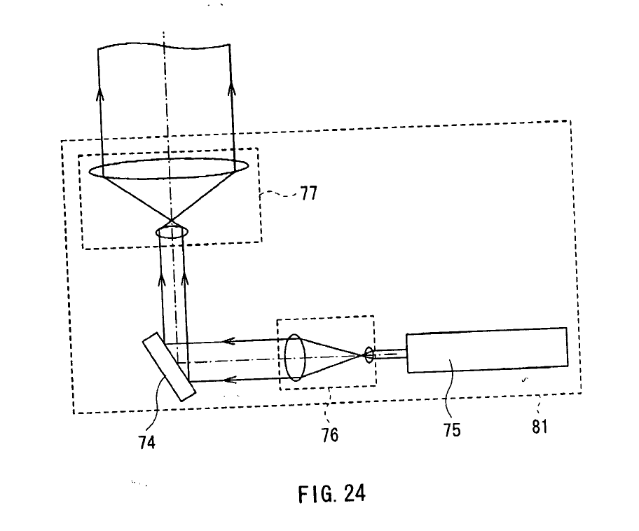

A structural example (Modification 6) shown in FIG. 24 shows a two-dimensional display section 81 using a laser light source 65 with high directivity. In other words, the two-dimensional display section 81 has the functions of the two-dimensional image generating means and the light collimation means. In the two-dimensional display section 81, in addition to the laser light source 75, a beam expander 76, the micromirror array 74 and a beam expander 77 are arranged in order from a side closer to the laser light source 75. Light emitted from the laser light source 75 has extremely high directivity, so the light can be treated as substantially parallel light. When the light emitted from the laser light source 75 passes through the beam expander 76, the diameter of the light flux is increased so as to have a substantially uniform distribution. Moreover, when the light flux passing through the beam expander 76 passes through the micromirror array 74, a two-dimensional image is generated. After the two-dimensional image is further expanded by the beam expander 77 if necessary, the two-dimensional image is outputted from the two-dimensional display section 81. In addition, instead of the laser light source 75, a light-emitting diode (LED) with high directivity can be used as a light source.

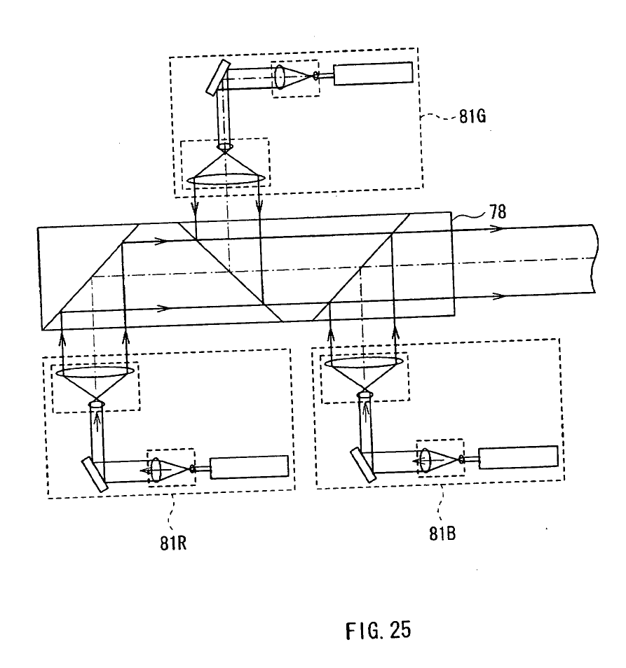

Two-dimensional image light outputted from the two-dimensional display section 81 is monochrome. Therefore, to obtain two-dimensional color image light, it is necessary to have a structure (Modification 7) shown in FIG. 25. FIG. 25 shows a structural example in which a two-dimensional display section 81R forming two-dimensional red image light, a two-dimensional display section 81G forming two-dimensional green image light, a two-dimensional display section 81B forming two-dimensional blue image light and a dichroic mirror prism 78 are combined. Thereby, when the two-dimensional image lights from these sections are mixed by the dichroic mirror prism 78, natural two-dimensional color image light can be obtained.

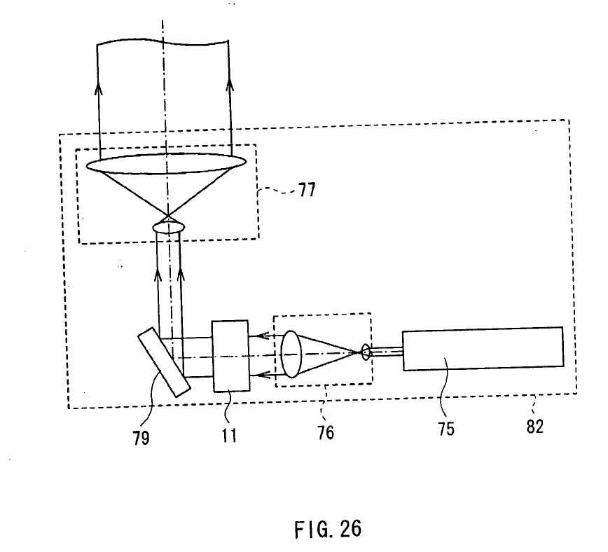

Moreover, instead of the micromirror array 64 in the two-dimensional display section 81 shown in FIG. 24, a liquid crystal device can be used to generate a two-dimensional image. More specifically, as shown in the two-dimensional display section 82 shown in FIG. 26, the liquid crystal device 11 and a mirror 79 may be arranged on an optical path (Modification 8).

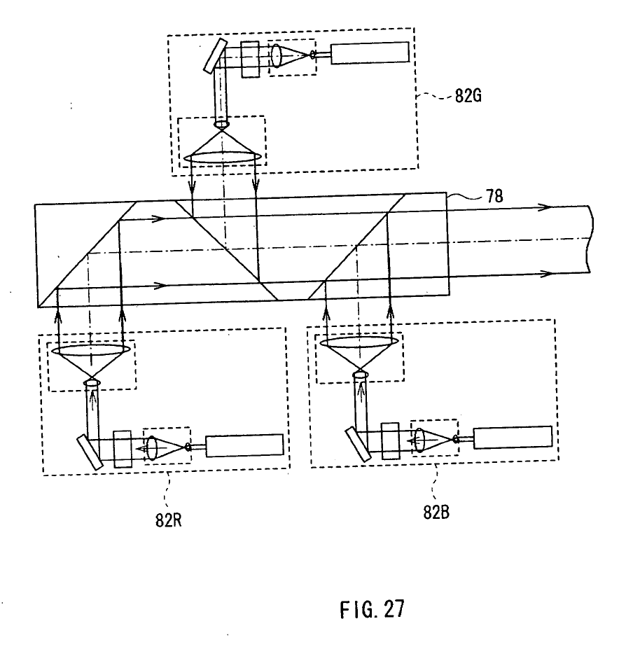

Further, as shown in a structural example (Modification 9) shown in FIG. 27, when a two-dimensional display section 82R forming two-dimensional red image light, a two-dimensional display section 82G forming two-dimensional green image light, a two-dimensional display section 82B forming two-dimensional blue image light and the dichroic mirror prism 78 are combined, two-dimensional color image light can be obtained.

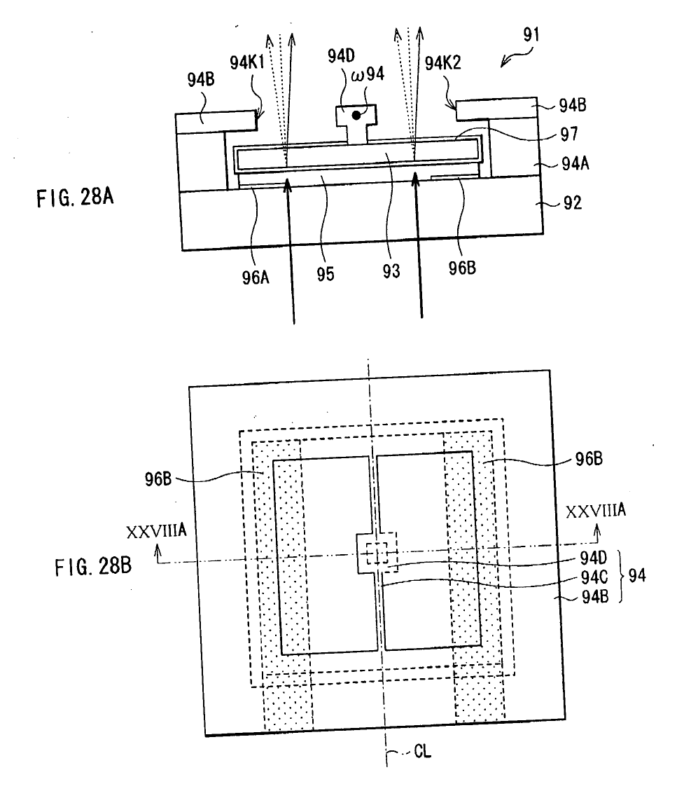

As the deflection section, a DMD-type light deflection device 91 shown in FIG. 28 may be used (Modification 10). The light deflection device 91 includes a transparent substrate 92 and a movable layer 93 which face each other and are made of a rigid material such as quartz, and a filling layer 95 which is made of silicone and filled between the transparent substrate 92 and the movable layer 93. The movable layer 93 is supported by a supporting section 94D which is a part of a support 94. The surface of the movable layer 93 is covered with the transparent electrode layer 97, and faces the transparent electrode layers 96A and 96B formed on the surface of the transparent substrate 92. Moreover, the supporting section 94D is connected to a support frame 94B via a pair of hinges 94C. The pair of hinges 94C have a central axis ω94 extending along a central line CL passing through the central position of the movable layer 93. The support frame 94B is arranged on the transparent substrate 92 with a column 94A in between.

In the light deflection device 91 with such a structure, a light flux entering from the transparent substrate 92 is emitted so as to pass through two openings 94K1 and 94K2 formed by the support frame 94B, the pair of hinges 94C and the supporting section 94D. At this time, when a voltage is applied between the transparent electrode layer 96A and the transparent electrode layer 97 or between the transparent electrode layer 96B and the transparent electrode layer 97 so as to rotate the movable layer 93 about the central axis ω94, the incident light flux can be deflected in a predetermined direction.

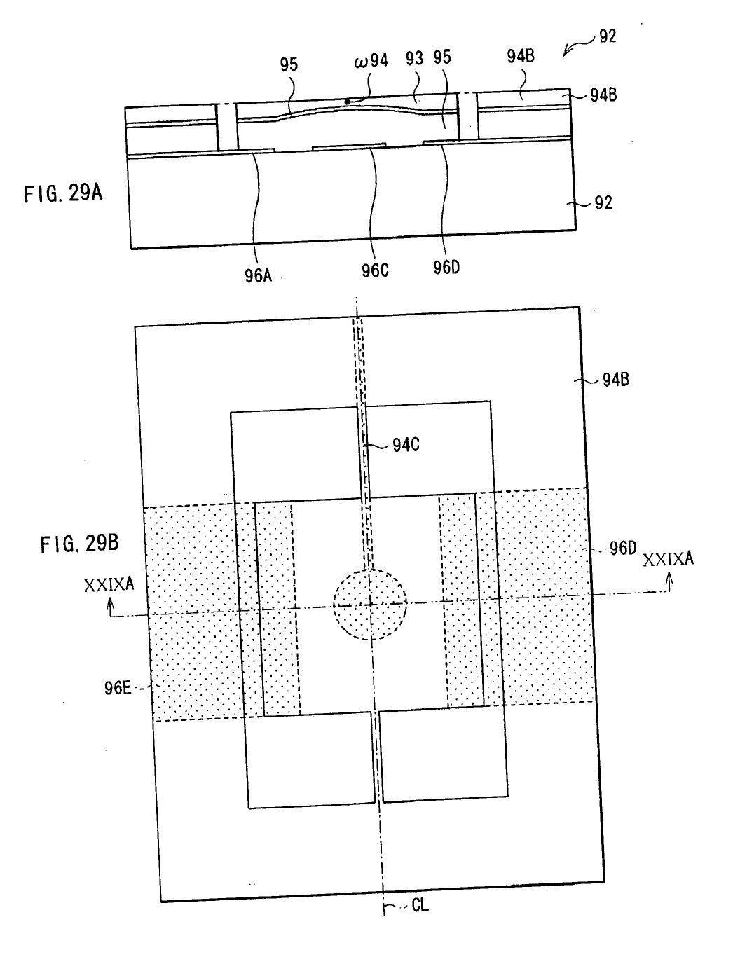

Further, as shown in FIGS. 29A and 29B, an optical device 92 having a lens function in addition to a deflection function may be used as a deflection means and a wavefront conversion means (Modification 11). The movable layer 93 is made of, for example, a polymer such as a transparent and flexible polyester material, and has a high elastic modulus. Therefore, when a voltage is applied between the transparent electrode layer 96C and the transparent electrode layer 97, a desired shape is formed, and the optical device 92 exerts an action of focusing or dispersing the incident light flux. Further, when a voltage is applied between the transparent electrode layers 96D and 96E and the transparent electrode layer 97, the movable layer 93 rotates about the central axis ω94 in the pair of hinges 94C to perform the deflection operation.

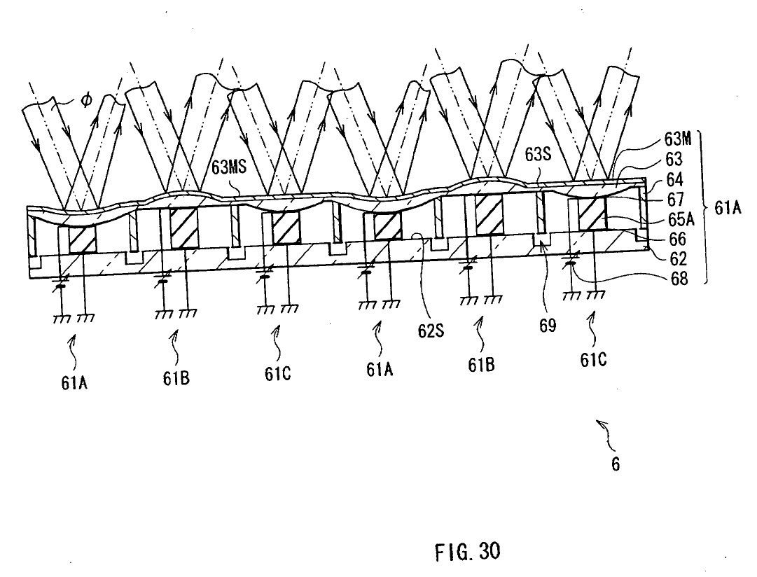

Moreover, in the second embodiment, the filling layer 65 is used to deform the reflective deformation member 63; however, the invention is not limited to this. For example, as shown in a variable focal-length mirror 61A as a modification (Modification 12) shown in FIG. 30, a piezo element 65A may be arranged between the electrode layers 66 and 67 instead of the filling layer 65. As the piezo element 65A, a thick film formed of, for example, lead zirconate titanate (PZT) by a sol-gel method or the like can be used.

Moreover, in the above embodiments, in the wavefront conversion means and the deflection means, the deformation is performed through the use of an attractive force in an electrostatic force acting between electrodes; however, a repulsive force may be actively used. For example, in the variable focal-length lens 31, the transparent deformation member 33 is formed so as to have a concave shape shown in FIG. 6B in a state where an electrostatic force is not generated between the transparent electrodes 36 and 37, and the variable focal-length lens 31 may be converted into a state shown in FIG. 6A by applying a voltage between the transparent electrodes 36 and 37, and applying a charge of the same sign to generate a repulsive force.

It should be understood by those skilled in the art that various modifications, combinations, sub-combinations and alterations may occur depending on design requirements and other factors insofar as they are within the scope of the appended claims or the equivalents thereof.

What is claimed is:

1. A three-dimensional display, comprising:
a two-dimensional image generating means for generating a two-dimensional display image based on an image signal;
a wavefront conversion means for converting the wavefront of display image light emitted from the two-dimensional image generating means into a wavefront having a curvature which allows the display image light to focus upon a focal point, an optical path length from an observation point to the focal point being equal to an optical path length from an observation point to a virtual object point; and
a deflection means for deflecting the display image light, the wavefront of the display image light being converted by the wavefront conversion means.

2. The three-dimensional display according to claim 1 further comprising:
a light source; and
a light collimation means for collimating light emitted from the light source into parallel light to emit the parallel light to the two-dimensional image generating means.

3. The three-dimensional display according to claim 1, further comprising:
a light collimation means for collimating each display image light from each of pixels constituting the two-dimensional image generating means into parallel light on a pixel-to-pixel basis to emit the parallel light to the wavefront conversion means.

4. The three dimensional display according to claim 3, wherein
the light collimatiion means includes positive lenses each arranged corresponding to each of pixels.

5. The three-dimensional display according to claim 3, wherein
the collimating means includes partition walls each arranged upright so as to be parallel to an optical axis, at least a surface portion of the partition wall being made of a material absorbing the display image light.

6. The three-dimensional display according to claim 1, wherein
the deflection means includes:
a horizontal deflection section deflecting display image light from the wavefront conversion means in a horizontal direction; and
a vertical deflection section deflecting the display image light in a vertical direction perpendicular to the horizontal direction.

7. The three-dimensional display according to claim 1, wherein the wavefront conversion means includes a variable focal-length mirror.

8. The three-dimensional display according to claim 7, wherein
the variable focal-length mirror includes:
a rigid layer;
an elastic layer arranged so as to face the rigid layer;
a reflective layer being arranged on an outer surface of the elastic layer; and
a pair of electrode layers, one of them arranged on a surface of the rigid layer, and another arranged on a surface of the elastic layer, and the elastic layer has an elastic-constant distribution which is nonuniform in a direction along its plane.

9. The three-dimensional display according to claim 1, wherein
the wavefront conversion means is a variable focal-length lens.

10. The three-dimensional display according to claim 9, wherein
the variable focal-length lens includes:
a rigid layer made of a transparent material;
an elastic layer arranged so as to face the rigid layer, the elastic layer being made of a transparent material;
a filling layer filled between the rigid layer and the elastic layer, the filing layer being made of a transparent material; and
a pair of transparent electrode layers, one of then arranged on a surface of the rigid layer, and another arranged on a surface of the elastic layer, and
the elastic layer has an elastic-constant distribution which is nonuniform in a direction along its plane.

11. The three-dimensional display according to claim 9, wherein the variable focal-length lens includes:
a rigid layer made of a transparent material;
an elastic layer arranged so as to face the rigid layer, the elastic layer being made of a transparent material;
a filling layer filled between the rigid layer and the elastic layer, the filling layer being made of a transparent material; and
a pair of transparent electrode layers, one of them arranged on a surface of the rigid layer, and another arranged on a surface of the elastic layer, the pair of transparent electrode layers forming an electric-field-intensity distribution in a direction along their plane.

12. The three-dimensional display according to claim 1, wherein
the deflection means is a light deflection device including:
a fixed layer made of a transparent material;
a movable layer arranged so as to face the fixed layer, the movable layer being made of a transparent material;
a filling layer filled between the fixed layer and the movable layer, the filling layer being made of a transparent material;
a pair of transparent electrode layers, one of them arranged on a surface of the fixed layer, and another arranged on a surface of the movable layer, the pair of transparent electrode layers forming an electric-field-intensity distribution which is nonuniform in a direction along their plane.

13. The three-dimensional display according to claim 1, wherein
the two-dimensional image generating means and the deflection means are in syncronization with each other.

14. The three-dimensional display according to claim 1, wherein
the wavefront conversion means and the deflection means are in syncronization with each other.

15. The three-dimensional display according to claim 12, wherein
the deflection means includes a horizontal deflection means and a vertical deflection means.

16. A three-dimensional display, comprising:
a two-dimensional image generator generating a two-dimensional display image based on an image signal;
a wavefront convertor converting the wavefront of display image light emitted from the two-dimensional image generator into a wavefront having a curvature which allows the display image light to focus upon a focal point, an optical path length from an observation point to the focal point being equal to an optical path length from the observation point to a virtual object point; and
a deflector deflecting the display image light, the wavefront of the display image light being converted by the wavefront convertor.
